(19) United States
(12) Patent Application Publication
(10) Pub. No.: US 2002/0095382 A1
(43) Pub. Date: Jul. 18, 2002

(54) Content decryption device

(76) Inventors: Hiroki Taoka, Osaka-shi (JP); Taihei Yugawa, Nara-shi (JP)

Correspondence Address: Joseph W. Price, PRICE and GESS, Suite 250, 2100 S.E. Main Street, Irvine, CA, 92614, US

(21) Appl. No.: 10/042,611

(22) Filed: Jan. 9, 2002

(30) Foreign Application Priority Data
Jan. 10, 2001 (JP) 2001-002177

(51) Int. Cl. H04K 1/00; H04L 9/00; G06F 17/60

(52) U.S. Cl. 705/50

(57) ABSTRACT

A decryption unit decrypts encrypted content to generate content. An instruction execution unit outputs a transfer destination address showing a position in a content output unit to an address detection unit. The address detection unit judges whether the transfer destination address matches a pre-stored permitted address, and outputs the generated content only when the transfer destination address and the permitted address match, to the position in the content output unit shown by the transfer destination address. The content output address receives the content and outputs the received content to an external device.

This application is based on an application No. 2001-002177 filed in Japan, the content of which is hereby incorporated by reference.

### BACKGROUND OF THE INVENTION

1. Field of the Invention

The present invention relates to a technique for decrypting and transferring digital content while maintaining security.

2. Description of the Related Art

In recent years it has become common for digital works such as digitized books, audio, images, programs, and so on to be encrypted and recorded onto SD memory cards and the like to be distributed. In such distribution, it is important to protect rights of the author so that the digital work cannot be used illegally.

Japanese Laid-open application no. 10-4403 discloses an encryption device, a decryption device, and a method therefor with an object of making illegal decoding of a secret key difficult by updating the secret key in every encryption process and decryption process.

This method generates a temporary key by processing a secret key and a random number with a symmetrical cipher algorithm, and processes the temporary key and a plain text to be encrypted or a cipher text to be decrypted with the symmetrical cipher algorithm to generate a cipher text or a plain text. Here, this temporary key is updated as a secret key before or after processing in every encryption process and every decryption process.

Furthermore, Japanese Laid-open application no. 11-306092 discloses a data processor with an object realizing protection of digital content flowing on a bus of a computer system and limiting the digital content of each function module.

The data processor has an interface with an external bus that is connectable with an external device. The external device has a authentication function for encrypting and transferring copy-protected data. In addition, the data processor is provided with an internal bus, a plurality of function modules, and authentication means. The plurality of function modules are linked to the internal bus via which they and transmit/receive copy-protected data. The authentication means is provided in each function module, and performs authentication for encrypting and transferring copy-protected content between the other function modules or an external device to/from which the copy-protected data is to be transferred. The data processor performs an authentication process for each function module.

However, even by using the above-described conventional techniques, it is difficult to completely prevent illegal use of digital contents by a third party. Therefore, there is a demand for a content decryption device that provides even safer protection of copy-protected content than the conventional techniques.

### SUMMARY OF THE INVENTION

In response to the aforementioned demand, the object of the present invention is to provide a content decryption device that decrypt and transfer content safely while maintaining an ability to download and freely execute software from an external device, and versatility as a content decryption device, while limiting operations based on illegal intent of a third party.

In order to achieve the above-described object, the present invention is a content decryption device that decrypts encrypted content that is recorded on a recording medium, and outputs the decrypted content to an external device, including: a decryption unit for decrypting the encrypted content to generate the decrypted content; and an instruction execution unit for decoding a transfer instruction that includes a transfer destination address showing a position of a content output unit in an address space as a transfer destination of the decrypted content to extract the transfer destination address, and outputting the extracted transfer destination address to an address detection unit; the address detection unit for pre-storing a permitted address that shows a transfer destination to which output of the decrypted content is permitted, judging whether the transfer destination address matches the permitted address, and outputting, only when the transfer destination address matches the permitted address, the decrypted content to the content output unit whose position is shown by the transfer destination address; and the content output unit for receiving the decrypted content, and outputting the received decrypted content to the external device.

According to the stated construction the content is output to the content output unit showing by the transfer destination address only when the transfer destination address to which decrypted content is to be transferred matches the pre-stored permitted address. Therefore, transfer of content to an illegal output unit according to specification of an illegal transfer destination address can be prevented.

Here, the decryption device may further include an obtaining unit for obtaining, from another external device, a decryption program including (a) a decryption instruction that shows decryption of encrypted content, and (b) a transfer instruction that includes the transfer destination address showing the position in the content output unit, and that shows transfer of the decrypted content to the content output unit, wherein the decryption unit decrypts the encrypted content according to the decryption instruction, and the instruction execution unit outputs the transfer destination address according to the transfer instruction.

According to the stated construction, the content is output to the content output unit shown by the transfer destination address only when the transfer destination address included in the decrypted program obtained from an external device match the pre-stored permitted address. Therefore, transfer of content to an illegal output unit according to specification of an illegal transfer destination address can be prevented even when the content is decrypted and output to the content output unit using the obtained program.

Furthermore, the present invention is a content decryption device that decrypts encrypted content and outputs the decrypted content to an external device, including: an obtaining unit for obtaining, from another external device, a decryption program that includes a program for decrypting encrypted content and outputting the decrypted content to the external device, and that includes first encrypted information and second encrypted information, the first encrypted information having been generated by encrypting a predetermined piece of information according to a first encryption, the second encrypted information having been generated by encrypting the predetermined piece of information according to a second encryption; a storage unit for storing the program; a decryption unit for decrypting the first encrypted information according to a first decryption to generate first decrypted information, and decrypting the second encrypted information according to a second decryption to generate second decrypted information, the first decryption being an inverse transformation of the first encryption, and the second decryption being an inverse transformation of the second encryption; and a judgement unit for judging whether the first decrypted information and the second decrypted information match, and when the first decrypted information and the second decrypted information are judged not to match, prohibiting execution of the program.

According to the stated construction, when two same pieces of predetermined information that have been encrypted by different encryption methods to obtain a first decrypted information and second decrypted information and the first information and the second information do not match, execution of the program is prohibited. Therefore execution of an illegal program generated by an illegal third party who does not know the predetermined information can be prevented.

Furthermore, the present invention is a content decryption device that decrypts encrypted content and outputs the decrypted content to an external device, including: data storage unit for storing (a) a first encrypted key that has been generated by encrypting a common key using a CPU unique key that is unique to a CPU, and (b) a second encrypted key that has been generated by encrypting a common key using a content processing unit unique key that is unique to a content processing unit; the CPU for performing execution of instructions, encryption of information, and decryption of information, and for generating a common key by decrypting the first encrypted key using the CPU unique key, and storing the generated common key, the content processing unit for (a) storing content, or outputting stored content to the external device, and (b) generating a common key by decrypting the second encrypted key using the content processing unit unique key.

According to the stated construction, a common key can be safely shared between the CPU and the content output unit without being known to a third party.

### BRIEF DESCRIPTION OF THE DRAWINGS

These and other objects, advantages and features of the invention will become apparent from the following description thereof taken in conjunction with the accompanying drawings which illustrate a specific embodiment of the invention. In the drawings:

FIG. 1 is an external view of a portable information terminal 10;

FIG. 2 is a block drawing showing the structure of the portable information terminal 10 and a memory card 20;

FIG. 3 shows an example of computer programs stored in a data saving unit 4;

FIG. 4 is a block drawing showing the construction of an encryption/decryption processing unit 103;

FIG. 5 shows a state table 701 in the encryption/decryption control unit 133;

FIG. 6 is a state transition drawing showing transitions in state of the encryption/decryption control unit 133;

FIG. 7 is a block drawing showing the structure of a key storage unit 104;

FIG. 8 is a block drawing showing the construction of a transfer destination address detection unit 108;

FIG. 9 is a block drawing showing the construction of an authentication outcome judgement unit 106;

FIG. 10 explains the relationship between a unique key and the variable key;

FIG. 11 is a flowchart showing operations of the portable information terminal 10 in more detail, and continues in FIG. 12;

FIG. 12 is a flowchart showing operations of the portable information terminal 10 in more detail, and continues from FIG. 11;

FIG. 13 is a flowchart showing operations of the state transition process of the encryption/decryption control unit 133;

FIG. 14 is a flowchart showing operations of each element in the encryption/decryption processing unit 103, and continues in FIG. 15;

FIG. 15 is a flowchart showing operations of each element in the encryption/decryption processing unit 103, and continues from FIG. 14;

FIG. 16 is a flowchart showing operations of a CPU 1 in executing a decryption program, and continues in FIG. 17;

FIG. 17 is a flowchart showing operations of the CPU 1 in executing a decryption program, and continues from FIG. 16;

FIG. 18 is a flowchart showing operations for authentication of a memory card;

FIG. 19 is a flowchart showing operations of the transfer destination address detection unit 108, and continues in FIG. 20;

FIG. 20 is a flowchart showing operations of the transfer destination address detection unit 108, and continues from FIG. 19;

FIG. 21 is a flowchart showing operations of a variable key updating program by the CPU 1;

FIG. 22 is a flowchart showing operations of a transfer destination address range updating program by the CPU 1;

FIG. 23 is a block drawing showing the construction of a portable information terminal lOa in an embodiment in which a recording medium I/F unit 7 is integrated with the CPU 1;

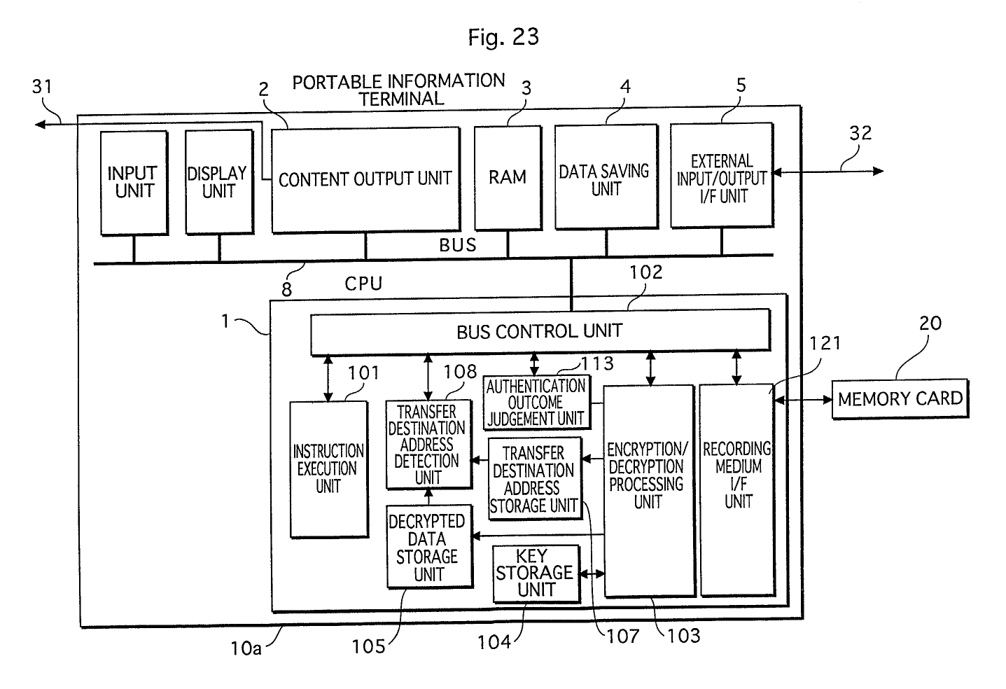

FIG. 24 is a block drawing showing the structure of a program setting system 50b;

FIG. 25 is a block drawing showing the structure of an encryption/decryption processing unit 103b;

FIG. 26 is a flowchart showing operations of a program setting device 40b and the portable information terminal 10b;

FIG. 27 is a block drawing showing the structure of a program setting system 50c;

FIG. 28 is a flowchart showing operations of a program setting device 40c and a portable information terminal 10c;

FIG. 29 is a block drawing showing the structure of a portable information terminal 10d;

FIG. 30 is a block drawing showing the structure of a content output unit 2d;

FIG. 31 is a flowchart showing operations between the CPU 1 and the content output unit 2d in key sharing;

FIG. 32 is a flowchart showing operations the CPU 1 in key sharing;

FIG. 33 is a flowchart showing operations of the content output unit 2d;

FIG. 34 is a flowchart showing operations of the CPU 1 and the content output unit 2d in key sharing, and in particular in operations for setting a next common key K1 of an initial value K0;

FIG. 35 is a state transition drawing showing transition in state by the encryption/decryption control unit 133;

FIG. 36 is a flowchart showing operation of state transition processing by the encryption/decryption control unit 133; and

FIG. 37 is a flowchart showing operations of a portable information terminal 10f.

### DESCRIPTION OF THE PREFERRED EMBODIMENTS

1. First Embodiment

The following describes a portable information terminal 10 as a first embodiment of the present invention.

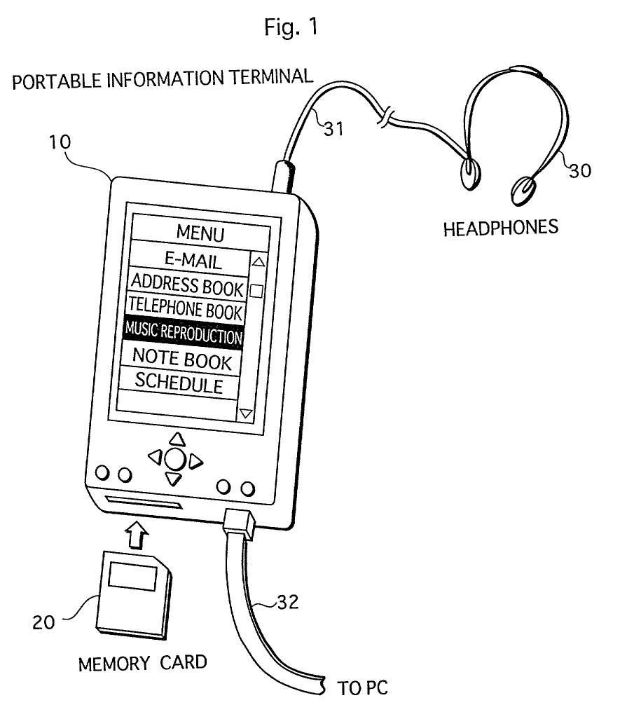

As FIG. 1 shows, the portable information terminal 10 includes a display unit and an input unit for user operation. The display unit is composed of an LCD (liquid crystal display), and displays an operation menu and various other information. The input unit is composed of a plurality of operation buttons, and receives input operations from the user. Furthermore, a memory card 20 in which a musical digital work is stored is connected to the portable information terminal 10, and headphones 30 which reproduce music, audio, and the like are connected to the personal information terminal 10 via a cable 30.

The user inserts the memory card 20 into the personal information terminal 10, and selects an alternative showing reproduction of music from amongst a number of alternatives in the operation menu displayed on the display. When the alternative has been selected, the personal information terminal 10 reads and decrypts encrypted content recorded on the memory card 20, then expands and converts the content to an analog signal, and outputs the analog signal to the headphones 30. In this way the user is able to reproduce and enjoy the music stored in the memory card 20.

1.1 Structure of the Memory Card 20

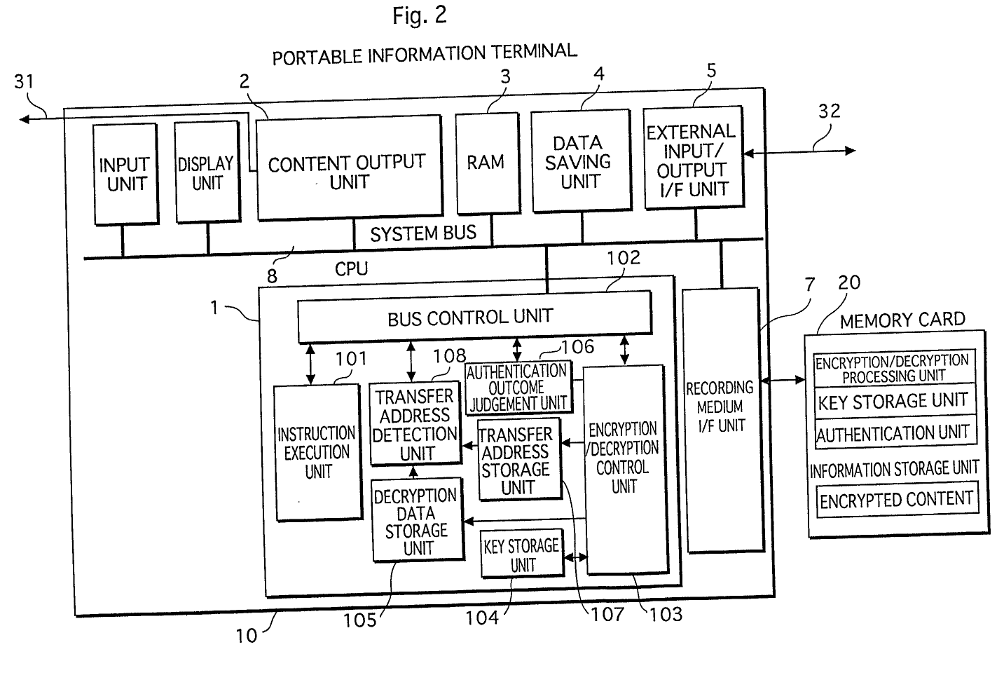

As FIG. 2 shows, the memory card 20 is composed of an encryption/decryption processing unit, a key storage unit, an authentication unit, and an information storage unit. The information storage unit stores the encrypted content.

The encryption/decryption processing unit encrypts plain text using a key, and decrypts cipher text using the key.

The key storage unit stores the key. The authentication unit performs device authentication between the portable information terminal 10 to which the memory card 20 is connected.

1.2 Structure of the Portable Information Terminal 10

As FIG. 2 shows, the portable information terminal 10 is composed of a central processing unit (hereinafter “CPU”) 1, a content output unit 2, a random access memory (hereinafter “RAM”) 3, a data saving unit 4, an external input/output I/F unit 5, a recording medium I/F unit 7, a system bus 8, an input unit, and a display unit.

As FIG. 2 shows, the CPU 1 is composed of an instruction execution unit 101, a bus control unit 102, an encryption/decryption processing unit 103, a key storage unit 104, a decrypted data storage unit 105, an authentication outcome judgement unit 106, a transfer destination address storage unit 107, and a transfer destination address detection unit 108.

The CPU 1, the content output unit 2, the RAM 3, the data saving unit 4, the external input/output I/F unit 5, the recording medium I/F unit 7, the input unit, and the output unit are connected to each other via the system bus 8.

The portable information terminal 10 achieves its functions according to operations of the CPU 1 following computer programs that are stored in the data saving unit 4.

There are cases in which computer programs that include instructions showing processing to decrypt and output encrypted content illegally are recorded in external devices. Even if the portable information terminal 10 obtains such a computer program from such an external device via the external input/output I/F 5 and the CPU 1 operates following the obtained program, the CPU 1 will still not execute instructions to transfer decrypted content.

(1) The data saving unit 4

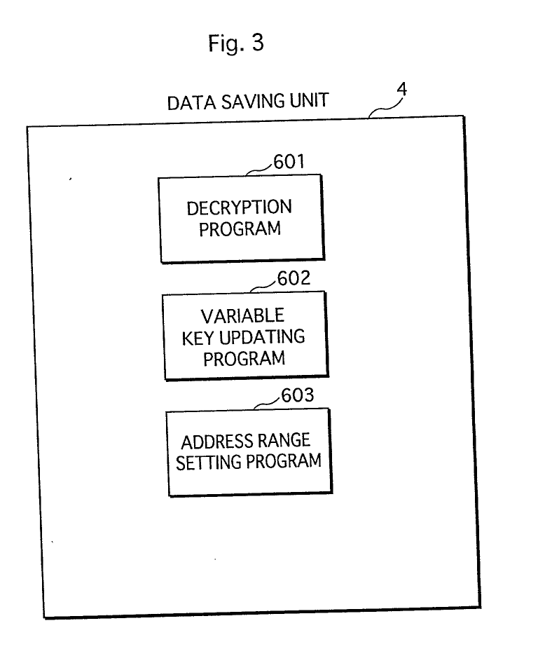

In detail, the data saving unit 4 is composed of a re-writable semi-conductor memory. The semi-conductor memory stores, as FIG. 3 shows, a decryption program 601, a variable key updating program 602, an address range setting program 603, and other computer programs and user data that are not illustrated.

The decryption program 601 is a computer program for decrypting encrypted content stored in the memory card 20. The decryption program 601 includes an authentication instruction showing authentication of the memory card 20, a decryption instruction showing decryption of encrypted content, a transfer instruction showing transfer of decrypted content to the content output unit 2, an output instruction showing expansion and output to an external device of content by the content output unit 2, and other instructions. The transfer instruction includes an address that shows the position of the content output unit 2 in the portable information terminal 10. The transfer destination of the content is shown by this address.

The variable key updating program 602 is a computer program for updating a variable key that is stored in the key storage unit 104 which is described later.

The address range setting program 603 is a computer program for updating an address range stored in the transfer destination address storage unit 107 which is described later.

Note that the data saving unit 4 may be composed of a hard disk unit.

(2) The content output unit 2

The content output unit 2 expands compressed multimedia data, one example of which is music data, converts digital data generated by expanding the compressed multimedia data to an analog signal, and outputs the generated analog signal via the cable 31 to the headphones 30.

A specified address in the portable information terminal 10 in an address space is allocated to the content output unit 2. The position of the content output unit 2 in the address space is shown by the allocated address.

This address is included in the transfer instruction in the decryption program 601.

(3) The external input/output I/F unit 5

In detail, the external input/output I/F unit 5 is based on the USB (Universal Serial Bus) specification. The external input/output I/F unit 5 is connected to an external device via a cable 32, and mediates transmission/reception of information between the system bus 8 and the external device.

Here, as one example, the external device is a personal computer system.

The user is able to obtain computer programs from the external device and update software saved in the data saving unit 4, through the external input/output I/F unit 5.

(4) The instruction execution unit 101 and the bus control unit 102.

The instruction execution unit 101 includes an instruction decoder, an arithmetic operation unit, and an internal RAM, and so on that a conventional CPU has. The instruction execution unit 10.1 operates following the computer programs stored in the data saving unit 4.

The instruction execution unit 101 judges which instruction from amongst a plurality of instructions that make up the computer programs stored in the data saving unit 4 should be executed by the encryption/decryption processing unit 103, and outputs the instruction that has been judged to be performed by the encryption/decryption processing unit 103 to the encryption/decryption control unit 133 in the encryption/decryption processing unit 103.

The instruction decoder, the arithmetic operation unit, the internal RAM in the instruction execution unit 101 operate following other instructions.

The bus control unit 102 controls the internal bus in the CPU 1, the system bus 8, and so on. All data input/output between the instruction execution unit 101 and the external units is transferred through the bus control unit 102.

(5) Encryption/decryption processing unit 103

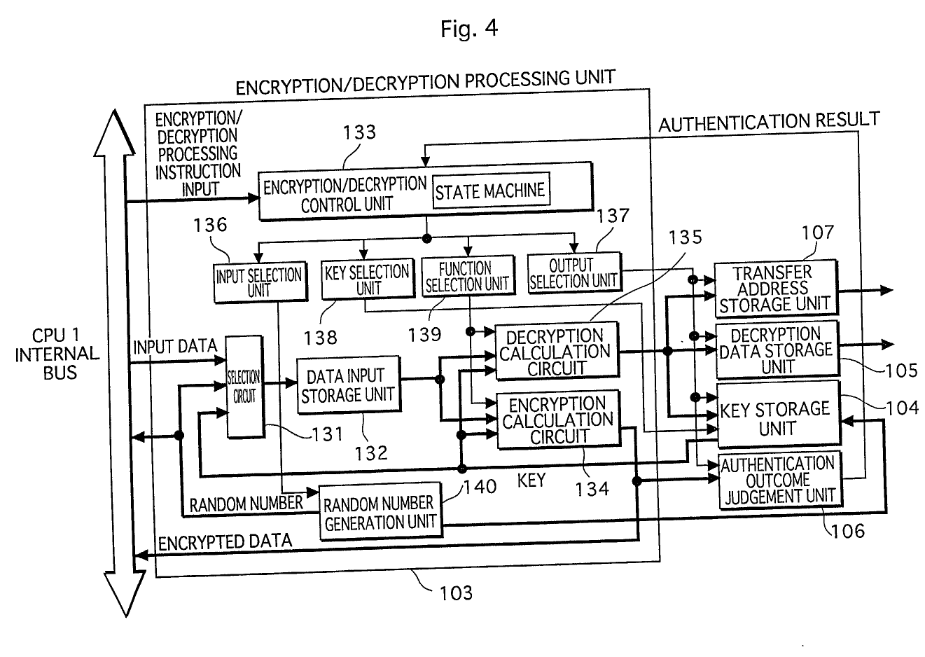

As FIG. 4 shows, the encryption/decryption processing unit 103 is composed of a selection circuit 131, a data input storage unit 132, an encryption/decryption control unit 133, an encryption calculation circuit 134, a decryption calculation circuit 135, an input selection unit 136, an output selection unit 137, a key selection unit 138, a function selection unit 139, and a random number generation unit 140.

Note that in FIG. 4 shows in detail how the above-described elements that are included in the encryption/decryption processing unit 103, and the key storage unit 104, the decrypted data storage unit 105, the authentication outcome judgement unit 106, and the transfer destination address storage unit 107 are connected.

<Encryption/decryption control unit 133>

The encryption/decryption control unit 133 receives the instruction judged by the encryption/decryption processing unit 103 to be the instruction to be executed, from the instruction execution unit 101.

Here, each instruction is formed including input original information, key information, function information, and an output destination. The input original information shows either information obtained via the system bus 8, information obtained from the key storage unit 104, or information obtained from the random number generation unit 140. The key information shows any of the keys stored in the key storage unit. The function information shows either the random number generation unit 140, the encryption calculation circuit 134, or the decryption calculation circuit 135. The output destination shows either the key storage unit 104, the decrypted data storage unit 105, or the transfer destination address storage unit 107. Furthermore, the output destination also shows any of the key areas (described later) in a key storage area 182 (described later) in the key storage unit 104. Furthermore, the output destination also shows one of the decryption calculation circuit 135 and the random number generation unit 140, which are the origin of inputs to the key storage unit 104.

On receiving the instruction, the encryption/decryption control unit 133 decodes the received instruction, and based on the decoded instruction, generates input selection information, key selection unit information, function selection information, and output selection information.

Here, the input selection information shows one of information notifying generation of a random number, information obtained via the system bus 8, information obtained from the key storage unit 104, and information obtained from the random number generation unit 140. The key selection information shows one of the keys stored in the key storage unit. The function selection information shows one of the encryption calculation circuit 134 and the decryption calculation circuit 135. The output selection information shows one of the key storage unit 104, the decrypted data storage unit 105, and transfer destination address storage unit 107. Furthermore, the output selection information also shows one of the key areas (described later) in the key storage area 182 (described later) of the key storage unit 104. Furthermore, the output selection information also shows one of the decryption calculation circuit 135 and the random number generation unit 140, which are the origin of inputs to the key storage unit 104.

Next, the encryption/decryption control unit 133 outputs the generated input selection information, key selection information, function selection information, and output selection information to the input selection unit 136, the key selection unit 138, function selection unit 139, and the output selection unit 137, respectively.

The content of the encryption/decryption process that the instruction execution unit 101 requests of the encryption/decryption processing unit 103, and the procedure for setting the data to be encrypted/decrypted are predetermined, and are provided in the encryption/decryption control unit 133 as a state machine.

In each of the states in the state machine, there is an instruction that the encryption/decryption processing unit 103 can execute and instructions that the encryption/decryption processing unit 103 cannot execute. For example, after initialization no matter what instruction the instruction execution unit 101 inputs into the encryption/decryption control unit 133, the encryption/decryption control unit 133 does not accept any instruction other than a variable key setting instruction. With this construction, it is judged whether the instruction execution unit 101 is inputting data into the encryption/decryption control unit 133 by the instruction execution unit 101 according to a predetermined procedure.

When an instruction is input that is executable in the state in the state machine, the encryption/decryption control unit 133 decodes the contents of the instruction, outputs selection signals corresponding to the decoded instruction to the input selection unit 136, the key selection unit 138, the function selection unit 139, and the output selection unit 137, as described above, and has encryption/decryption calculation executed. In a case of an instruction that encryption/decryption control unit 133 cannot execute, the selection signals are not output from the selection module, and encryption/decryption calculation is not executed.

The following describes the operations of the state machine in detail.

The encryption/decryption control unit 133 is in one of a variable key setting wait state, a transfer destination address range setting wait state, an external recording medium authentication wait state, and a content decryption state. A status flag shows which of the states the encryption/decryption control unit 133 is in. The status flag takes the values “00”, “01”, “10”, and “11” which correspond to the variable key wait state, the transfer destination address range setting wait state, the external recording medium authentication wait state, and a content decryption state respectively. Here, these values are displayed as binary digits. Note that the value of the status flag is “00” directly after the portable information terminal 10 has been turned on.

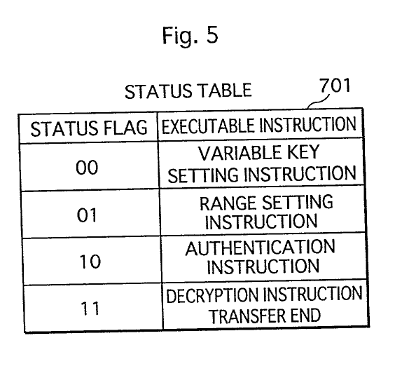

Furthermore, the encryption/decryption control unit 133 has a state table 701 as FIG. 5 shows. The state table 701 shows which instruction the encryption/decryption control unit 133 can be executed in each of the states. For example, when the status flag is “00”, in other words in the variable key setting wait state, the instruction that can be executed by the encryption/decryption control unit 133 is the variable key setting instruction, and no other instruction can be executed in this state. Likewise, when the status flag is “01”, “10”, and “11”, the instructions that can be executed are the range setting instruction, the authentication instruction, and the decryption instruction/transfer end respectively.

Here, the variable key setting instruction is an instruction for setting the variable key in the key storage unit 104, the range setting instruction is an instruction for setting the transfer destination address in the transfer destination address storage unit 107, the authentication instruction is an instruction for performing device authentication between the portable information terminal 10 and the memory card 20, the decryption instruction is an instruction for decrypting encrypted content, and transfer end is information showing that transferring of the decrypted content to the content output unit 2 has ended.

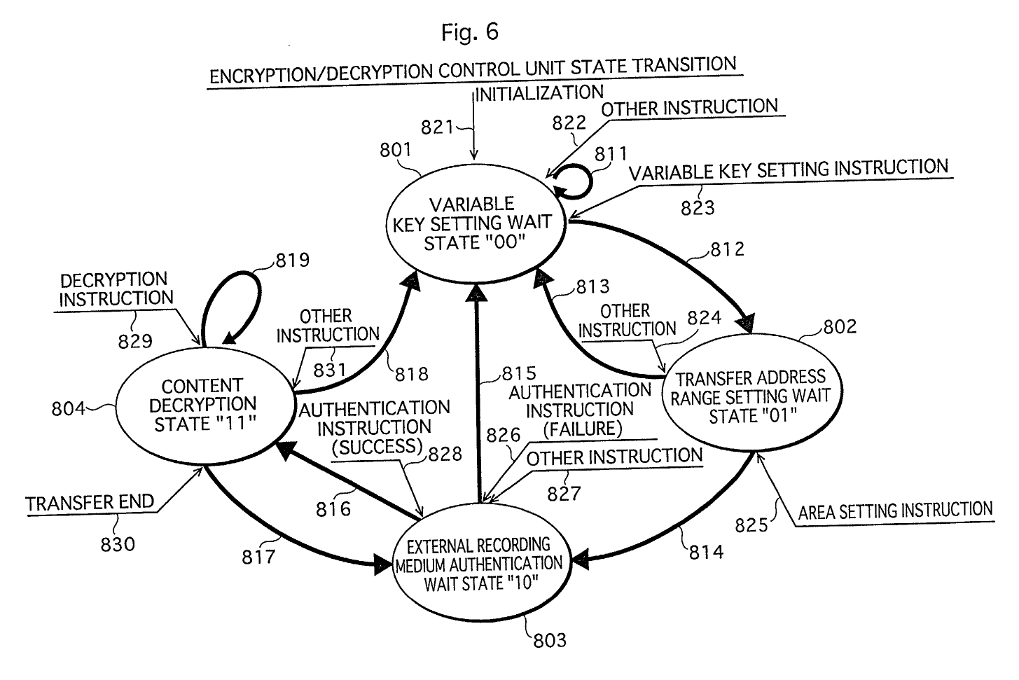

Next, the state transition in the encryption/decryption control unit 133 is described with use of the state transition drawing in FIG. 6. Note that in FIG. 6 each of the thin arrows shows an event taking place, while each of the thick arrows shows the state transition that follow the events.

When a variable key has been initially set in the key storage unit 104 (event 821), the encryption/decryption control unit 133 moves to the variable key setting wait state 801 (hereinafter “state 801”).

On receiving a variable key setting instruction in the state 801 (event 823), the encryption/decryption control unit 133 transitions to the transmission address range setting wait state 802 (hereinafter “state 802”) (812).

On receiving an instruction other than the variable key setting instruction in the state 801 (event 822), the encryption/decryption control unit 133 maintains the state 801 (811).

On receiving a range setting instruction in the state 802 (event 825), encryption/decryption control unit 133 transitions to the external recording medium authentication wait state (hereinafter “state 803”) (814).

On receiving an instruction other than the range setting instruction in the state 802 (event 824), the encryption/decryption control unit 133 transitions to the state 801 (813).

On authentication success after receiving an authentication instruction in the state 803 (event 828), the encryption/decryption control unit 133 transitions to the content decryption state 804 (hereinafter “state 804”) (816).

On authentication failure after receiving an authentication instruction (event 826) or on receiving an instruction other than an authentication instruction (event 827) in the state 803, the encryption/decryption control unit 133 transitions to the 801 (815).

On receiving a decryption instruction in the state 804 (event 829) the encryption/decryption control unit 133 stays in the state 804 (819).

On receiving information showing the end of transmission in the state 804 (event 830), the encryption/decryption control unit 133 transitions to the state 803 (817).

On receiving an instruction other that the decryption instruction and the information showing the end of transmission in the state 804 (event 831) the encryption/decryption control unit 133 transitions to the state 801 (818).

In this way, the encryption/decryption control unit 133 executes only the instruction corresponding to each state. Therefore the encryption/decryption control unit 133 can be constructed so that it cannot proceed to the next step even if an instruction that does not correspond to a particular state is received.

<Input selection unit 136>

The input selection unit 136 receives the input selection information from the encryption/decryption control unit 133.

When the received information is notification to generate a random number, the input selection unit 136 outputs the input selection information to the random number generation unit 140.

When the received input selection information is one of information obtained via the system bus 8, information obtained from the key storage unit 104, and information obtained from the random number generation unit 140, the input selection unit 136 outputs the input selection information to the selection circuit 131.

<Selection circuit 131>

The selection circuit 131 receives the input selection information from the input selection unit 136.

The selection circuit 131 selects, based on the input selection information, one signal line from amongst the three types that are being input into the selection circuit 131 from the instruction execution unit 101, the key storage unit 104, and the random number generation unit 140 to be connected to the encryption calculation circuit 134 or the decryption calculation circuit 135 via the data input storage unit 132.

Specifically, when the received input selection information is one of information obtained via the system bus 8, information obtained from the key storage unit 104, and information obtained from the random number generation unit 140, the selection circuit 131 selects information from the system bus 8, information from the key storage unit 104, and information from the random number generation unit 140, respectively, and outputs the selected information to the data input storage unit 132.

<Data input storage unit 132>

The data input storage unit 132 receives information from the selection circuit 131, stores the received information temporarily, organizes the stored information into a size that can be output to the encryption calculation circuit 134 or the decryption calculation circuit 135, and then outputs the organized information to the encryption calculation circuit 134 or the decryption calculation circuit 135.

For example, when the data input storage unit 132 receives information via the internal bus from the instruction execution unit 101, the instruction execution unit 101 handles 16-bit words. When the encryption calculation circuit 134 or the decryption calculation circuit 135 processes in 64-bit units, the data input storage unit 132 temporarily stores four time's worth of information from the instruction execution unit 101, and outputs the four time's worth of information to the encryption calculation circuit 134 or the decryption calculation circuit 135. Likewise, when the received data is a 56-bit key, the data input storage unit 132 performs processing such as adding a redundant bit to the first or last eight bits.

<Key selection unit 138>

The key selection unit 138 receives the key selection information from the encryption/decryption control unit 133, and outputs the received key selection information to the key storage unit 104.

<Function selection unit 139>

The function selection unit 139 receives the function selection information from the encryption/decryption control unit 133, and outputs the received function selection information to the encryption calculation circuit 134 and the decryption calculation circuit 135.

<Output selection unit 137>

The output selection unit 137 receives the output selection information from the encryption/decryption control unit 133, and outputs the received output selection information to the transfer destination address storage unit 107, the decrypted data storage unit 105, the key storage unit 104, authentication outcome judgement unit 106.

<Encryption calculation circuit 134>

The encryption calculation circuit 134 receives the information from the data input storage unit 132, receives the key information from the key storage unit 104, and receives the function selection information from the function selection unit 139.

When the received function selection information shows the encryption calculation circuit 134, the encryption calculation circuit 134 uses the received key information as a key to encrypt the information received from the data input storage unit 132, generates encrypted information, and outputs the generated encrypted information to the authentication outcome judgement unit 106, and via the internal bus to the system bus 8.

In this way the output result of the encryption calculation circuit 134 can be transferred to the instruction execution unit 101 through the internal bus of the CPU 1.

<Decryption calculation circuit 135>

The decryption calculation circuit 135 receives information from the data input storage unit 132, receives key information from the key storage unit 104, and receives function information from the 139.

When the received function information shows the decryption calculation circuit 135, the decryption calculation circuit 135 uses the key information received from the key storage unit 104 to decrypt the information received from the data input storage unit 132, generates decrypted information, and outputs the decrypted information to the transfer destination address storage unit 107, the decrypted data storage unit 105, and the key storage unit 104.

In this way the output target of the output result of the decryption calculation circuit 135 is limited.

<Random number generation unit 140>

The random number generation unit 140 receives input selection information notifying generation of a random number, from the input selection unit 136. On receiving the input selection information, the random number generation unit 140 generates a random number, and outputs the generated random number to the selection circuit 131, and via the internal bus to the system bus 8 and the key storage unit 104.

The output destination of the random number differs according to how the random number is to be used. When the random number it to be used to generate new key data, it is output to the key storage unit 104. When the random number is to be used in authentication with the memory card 20, it is first output to the selection circuit 131, and then after being encrypted by the encryption calculation circuit 134, is output via the internal bus to the authentication outcome judgement unit 106.

(6) Decrypted data storage unit 105

The decrypted data storage unit 105 includes an area for storing information.

The decrypted data storage unit 105 receives output selection information from the output selection unit 137, and also receives decrypted information from the decryption calculation circuit 135.

When the received output selection information shows the decrypted data storage unit 105, the decrypted data storage unit 105 stores the received decryption information.

In this way, the decrypted data storage unit 105 is a module for storing data (content and so on) that has been decrypted by the encryption/decryption processing unit 103, and outputs the stored data only to the transfer destination address detection unit 108.

(7) Transfer destination address storage unit 107

The transfer destination address storage unit 107 is a module for storing a transfer destination address range showing where data stored in the decrypted data storage unit 105 should be transferred to. The transfer destination address range is provided in the register so as to be updateable.

The transfer destination address storage unit 107 includes an area for storing information.

The transfer destination address storage unit 107 receives output selection information from the output selection unit 137, and also receives decrypted information from the decryption calculation circuit 135.

When the received output selection information shows the transfer destination address storage unit 107, the transfer destination address storage unit 107 stores the received decryption information. Here, the decrypted information is the transfer destination address range.

Furthermore, writing of the transfer destination address range to the transfer destination address storage unit 107 is only possible from the decryption calculation circuit 135 in the encryption/decryption processing unit 103. In other words, an encrypted transfer destination address range is pre-generated by encrypting the transfer destination address range using the variable key that is unique to the CPU 1, and this encrypted transfer destination address range is output to the encryption/decryption control unit 133. The decryption calculation circuit 135 decrypts the encrypted transfer destination address range to generate the transfer destination address range which it writes to the registers. The transfer destination address range cannot be updated by any other method.

Note that here the address range may be provided as a set value in terms of the hardware.

(8) Key storage unit 104

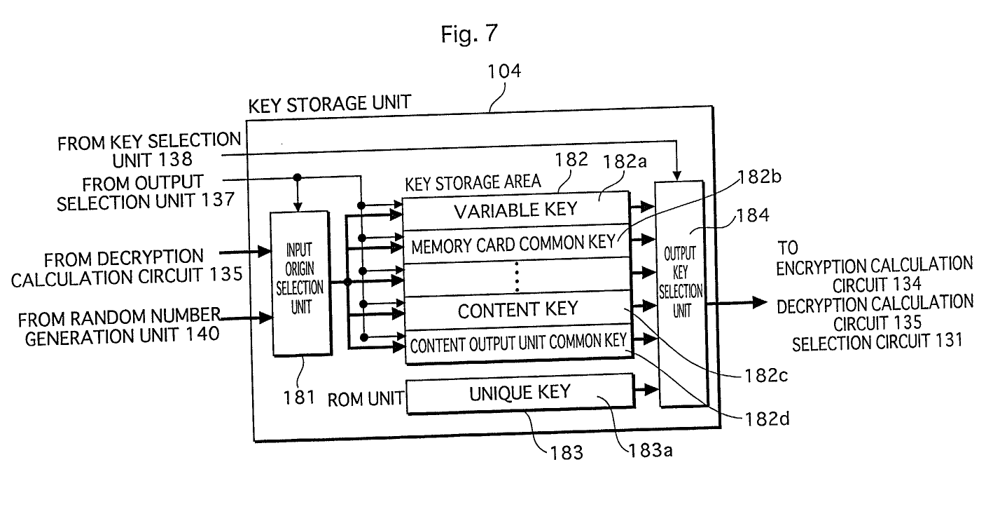

The key storage unit 104 is a module for storing keys that are used by the encryption/decryption processing unit 103, and as FIG. 7 shows, is composed of an input origin selection unit 181, a ROM unit 183, and an output key selection unit 184.

<Key storage area 182>

As FIG. 7 shows, the key storage area 182 has a plurality of key areas 182a, 182b, . . . , 182c, and 182d. Each of the key areas 182a, 182b, . . . , 182c, and 182d is an area for storing one key, and the type of key stored in each key area is predetermined.

As one example, the key areas 182a, 182b, . . . , 182c, and 182d store a variable key, a common key that is common with the memory card 20 (hereinafter “memory card 20 common key”), . . . , a content key, and a common key that is common with the content output unit 2 (hereinafter “content output unit 2 common key”), respectively.

Here, the variable key is a unique key that is assigned only to the CPU 1. This variable key is updated depending on circumstances, as described below.

The memory card 20 common key common to the CPU 1 and the memory card 20. In other words, the memory card 20 also has this key.

The content key is used when decrypting encrypted content recorded on the memory card 20.

The content output unit 2 common key is common to the CPU 1 and the content output unit 2. In other words, the content output unit 2 also has this key.

The key storage area 182 receives information from the input origin selection unit 181, and also receives output selection information from the output selection unit 137. The key storage area 182 selects one of the key areas 182a, 182b, . . . , 182c, and 182d according to the output selection information, and writes the information received from the input origin selection unit 181 to the selected area.

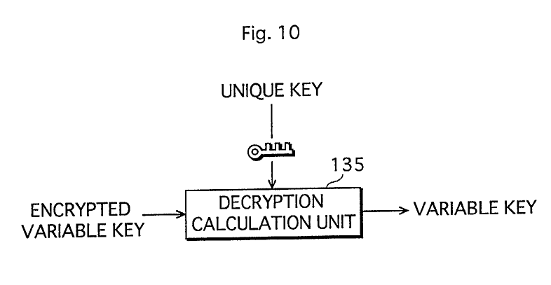

Here, the variable key and the unique key that are unique to the CPU 1 are described with use of FIGS. 10.

The variable key is for directly encrypting secret information, and in terms of security it is not desirable for this key to have a set value that is stored in the key storage unit 104 and continuously used.

Therefore, the unique key is recorded as a set value in the ROM unit 183 of the key storage unit 104. This unique key is known only to the manufacturer of the CPU 1 who uses this unique key to encrypt the variable key to generate an encrypted variable key, and stores the generated encrypted variable key in the data saving unit 4.

The instruction execution unit 101 reads the encrypted variable key from the data saving unit 4, and outputs the read encrypted variable key to the encryption/decryption processing unit 103. The encryption/decryption processing unit 103, as FIG. 10 shows, decrypts the encrypted variable key using the unique key stored in the key storage unit 104 to generate a variable key, and writes the generated variable key in the key storage unit 104.

In this way the variable key is set in the key storage unit 104.

When the manufacturer of the CPU 1 wishes to update the variable key, the manufacturer may use the unique key to encrypt another variable key to generate an encrypted variable key, and store the generated encrypted variable key in the data saving unit 4.

<ROM unit 183>

In detail, the ROM unit 183 is composed of a ROM that is readable but not rewritable, and that has one key are 183a. The key area 183a includes an area for storing one key, and a unique key is pre-stored in this area.

Here, the unique key is a key that is unique to and only allocated to the CPU 1. This unique key is not updated.

<Output key selection unit 184>

The output key selection unit 184 receives key selection information from the key selection unit 138, reads key information shown in the received key selection information from the key storage area 182, and outputs the read key information to the encryption calculation circuit 134, the decryption calculation circuit 135, and the selection circuit 131.

<Input origin selection unit 181>

The input origin selection unit 181 receives output selection information from the output selection unit 137, selects, according to the received output selection information, either information output from the decryption calculation circuit 135 or information output from the random number generation unit 140, and outputs the selected information to the key storage area 182.

As described, the key storage unit 104 is a module for storing keys used by the encryption/decryption processing unit 103. Input to the registers of the key storage unit 104 of key data that is saved therein is only possible, as FIG. 4 shows, from the output terminal of the decryption calculation circuit 135 in the encryption/decryption processing unit 103, or from the random number generation unit 140.

Therefore, in updating the value of key information recorded in the registers of the key storage unit 104, it is necessary to input the value of the key to be set to the encryption/decryption processing unit 103 in an encrypted state according to the software executed in the instruction execution unit 101.

Furthermore, as shown in FIG. 4, the registers in the key storage unit 104 can only output to the encryption calculation circuit 134, the key input terminal of the decryption calculation circuit 135, and the data input storage unit 132. This means that key data is not transferred in a raw state to modules other than the encryption/decryption processing unit 103 such as the instruction execution unit 101.

(9) Transfer destination address detection unit 108

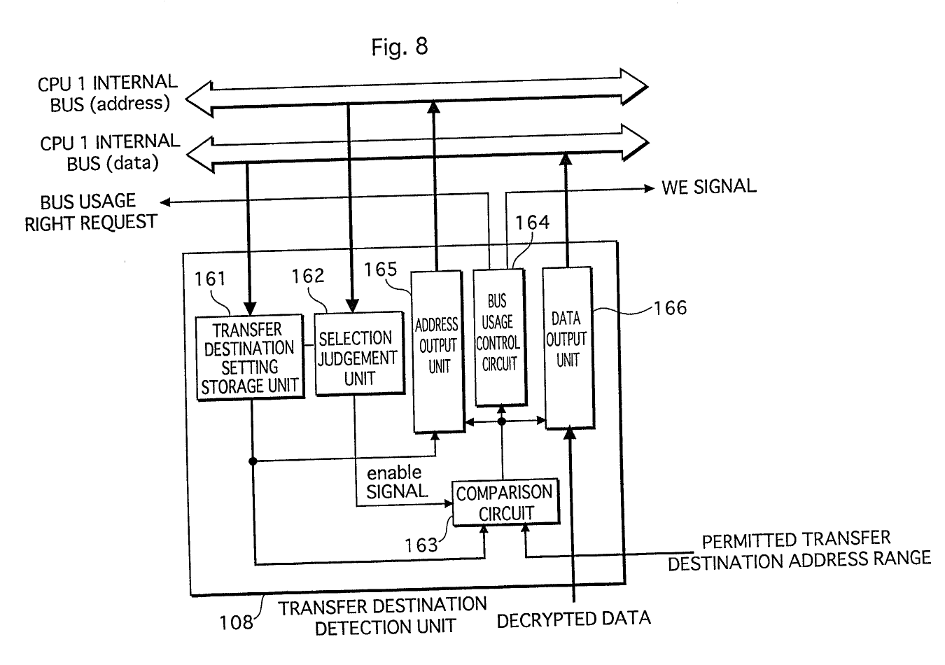

As FIG. 8 shows, the transfer destination address detection unit 108 is composed of a transfer destination setting storage unit 161, a selection judgement unit 162, a comparison circuit 163, a bus usage control unit 164, an address output unit 165, and a data output unit 166.

<Transfer destination setting storage unit 161>

The transfer destination setting storage unit 161 is a module for storing a transfer destination address range which shows where data stored in the decrypted data storage unit 105 should be transferred. This transfer destination address range is provided so as to be updateable in the registers.

The instruction execution unit 101 specifies an address in the registers of the transfer destination setting storage unit 161, and stores a data transfer address of the decrypted data storage unit 105 in the transfer destination setting storage unit 161.

<Selection judgement unit 162>

When an address in the registers of the transfer destination setting storage unit 161 is specified by the instruction execution unit 101, in other words when the address in the registers is specified in the CPU 1 internal bus line, the selection judgement unit 162 detects that the internal bus address line is specifying the registers of the transfer destination setting storage unit 161 and simultaneously outputs an enable signal to the 163.

<Comparison circuit 163>

On detecting the enable signal, the comparison circuit 163 judges whether the transfer destination address set in the transfer destination setting storage unit 161 is included in the address range specified in the transfer destination address storage unit 107, and outputs a judgement result showing whether the transfer destination address is included in the address range to the bus usage control unit 164, the address output unit 165, and the data output unit 166.

<Bus usage control unit 164, address output unit 165, and data output unit 166>

On receiving the judgement result from the comparison circuit 163, the bus usage control unit 164 outputs a signal to the instruction execution unit 101 requesting a right to use the bus.

The address written in the transfer destination setting storage unit 161 is connected to the address output unit 165. The decrypted data stored in the decrypted data storage unit 105 is connected to the data output unit 166.

On receiving a bus usage right from the instruction execution unit 101, the bus usage control unit 164 outputs a WE signal. The address output unit 165 outputs the address written in the transfer destination setting storage unit 161 to the internal bus address line. The data output unit 166 outputs the decoded data stored in the decrypted data storage unit 105 to the internal bus data line.

(10) Authentication outcome judgement unit 106

The authentication outcome judgement unit 106 is a module for performing authentication between the CPU 1 and the memory card 20, based on a method called the challenge-response authentication protocol.

The CPU 1 and the memory card 20 already have a common key. The CPU 1 verifies the memory card 20 as being a legitimate device on judging that the memory card 20 has the same common key as the CPU 1 itself.

The procedure for the authentication process is as follows.

First, the CPU 1 generates a random number, uses its own common key to encrypt the random number to generate a first encrypted random number, and sends the random number to the memory card 20. The memory card 20 receives the random number, uses its own common key to encrypt the received random number to generate a second encrypted random number, and transmits the second encrypted random number to the CPU 1. The CPU 1 receives the second encrypted random number and compares the first encrypted random number and the second encrypted random number. If the encrypted random numbers are the same, the CPU 1 judges that the memory card has the same common key as the CPU 1. In this case the CPU 1 recognizes the memory card 20 as a legitimate device.

In such an authentication method using a random number, since it is necessary to respond with an appropriate value according to the random number, it is usually difficult to succeed without knowing the actual common key. Therefore, this approach is often used in eliminating illegal modules.

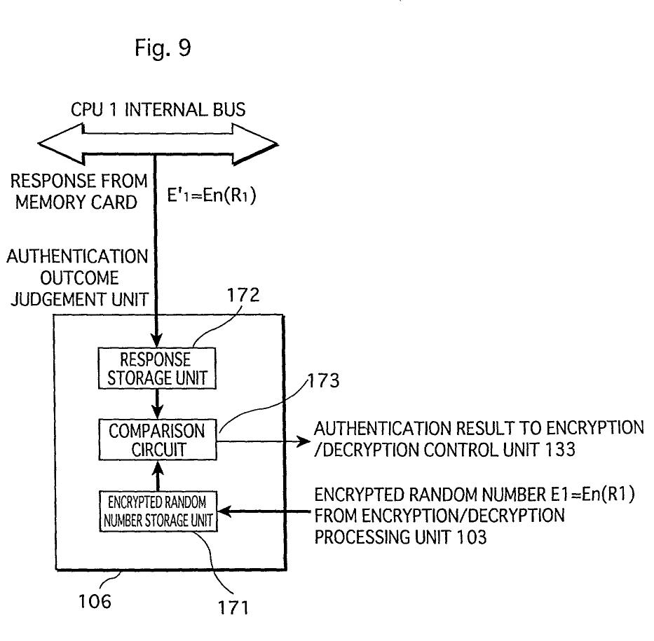

As FIG. 9 shows, the authentication outcome judgement unit 106 is composed of an encrypted number storage unit 171, a response storage unit 172, and a comparison circuit 173.

<Response storage unit 172>

The response storage unit 172 stores data received from the memory card 20 with which authentication is being performed.

The data is data generated by the memory card 20 using its own common key to encrypt the random number received from the CPU 1. In other words, the data is the aforementioned second encrypted random number.

<Encrypted number storage unit 171>

The encrypted number storage unit 171 receives from the encryption/decryption processing unit 103 the first encrypted random number that has been obtained by encrypting a random number using the common key, and stores the received first encrypted random number.

<Comparison circuit 173>

The comparison circuit 173 reads the second encrypted random number from the response storage unit 172, reads the first encrypted random number from the encrypted number storage unit 171, compares the two encrypted random numbers, and judges authentication to have succeeded if the two encrypted random numbers are equivalent. If the two encrypted random numbers are not equivalent the comparison circuit 173 judges authentication to have failed.

The comparison circuit 173 outputs an authentication result showing whether authentication has failed or succeeded to the encryption/decryption control unit 133.

(11) Recording medium I/F unit 7

The recording medium I/F unit 7, under the control of the portable information terminal 10, reads the information recorded on the memory card 20 and outputs the read information to the system bus 8.

1.3 Operations of the portable information terminal 10 and the memory card 20

The following describes operations of the portable information terminal 10 and the memory card 20.

(1) Overview of operations of the portable information terminal 10 and the memory card 20

The following describes the operations of the portable information terminal 10 and the memory card 20 in reading content from the memory card 20 and transferring the read content to the content output unit 2.

The recording medium I/F unit 7 reads encrypted content from the memory card 20. The instruction execution unit 101, according to a data transfer instruction, transfers the encrypted content to the encryption/decryption processing unit 103 via the RAM 3 or the internal RAM in the instruction execution unit 101.

Next, the encryption/decryption processing unit 103 decrypts the encrypted content to generate content, and writes the generated content to the decrypted data storage unit 105. An address range corresponding to the registers of the encryption/decryption processing unit 103 in the CPU 1 and the content output unit 2 is registered in the transfer destination address storage unit 107.

Next, the instruction execution unit 101 sets an address corresponding to the content output unit 2 which is a legal transfer destination, in the transfer destination setting storage unit 161 in the transfer destination address detection unit 108. When the comparison circuit 163 has confirmed that the set address is included the address range specified in the transfer destination address storage unit 107, the decrypted content is output by the data output unit 166 to the content output unit 2.

When the address value set in the transfer destination setting storage unit 161 by the instruction execution unit 101 corresponds to the external input/output I/F 5, the address value is judged in the comparison circuit to not be included in the address range set in the transfer destination address storage unit 107. Therefore, the bus usage control unit 164 does not output a bus usage right request, and the decoded content stored in the decrypted data storage unit 105 is not transferred anywhere.

(2) Operations of the portable information terminal 10

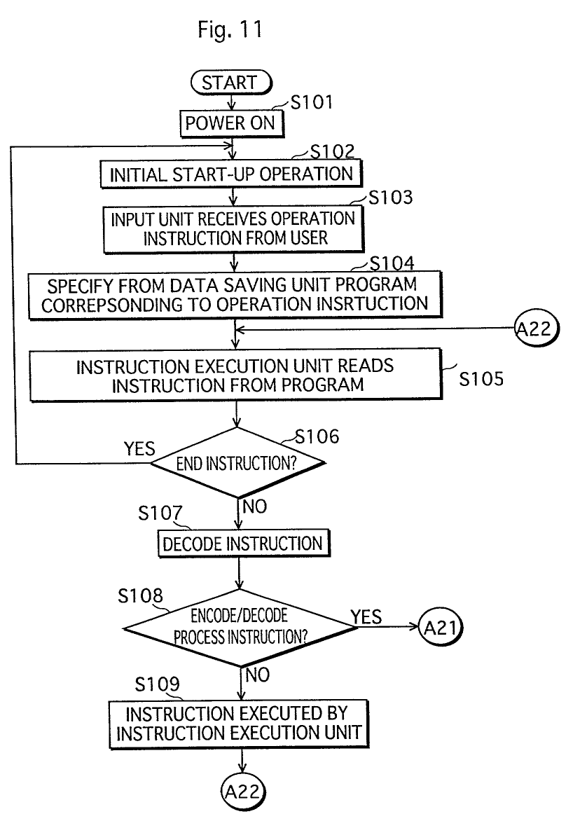

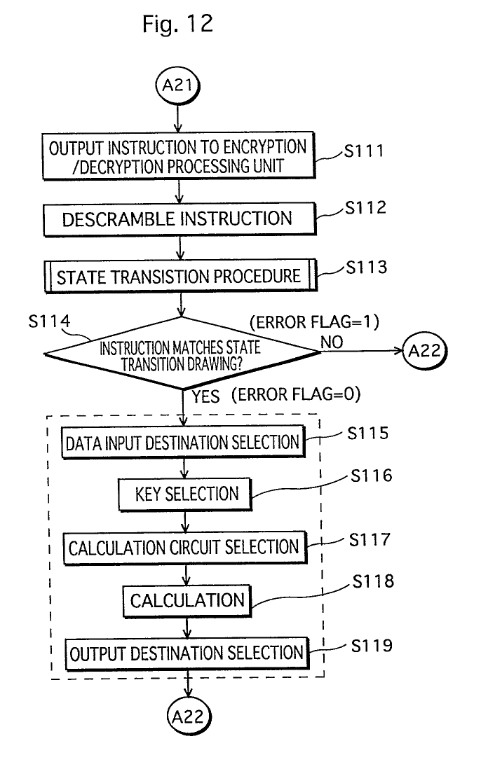

The following describes the operation of the portable information terminal 10 in further detail with use of the flowcharts in FIGS. 11 and 12.

The portable information terminal 10 receives an operation from the user to turn the power on (step S101), and performs an initial start-up operation (step S102).

Next, the input unit receives an instruction from the user regarding an operation (step S103), and specifies a computer program from among those in the data saving unit 4 corresponding to the received operation (step S104). The instruction execution unit 101 reads one instruction at a time from the specified program (step S105).

If a read instruction shows that the instructions have finished (step S106), the process returns to step S103 and is repeated.

If the read instruction does not show that the instructions have ended (step S106), the instruction execution unit 101 decodes the read instruction (step S107). If the result of the decoding is that the read instruction does not regard encryption and decryption (step S108), the instruction execution unit 101 executes the instruction based on the result of the decoding (step S109), returns to step S105, and repeats the process.

If the read instruction is regarding encryption and decryption (step S108), the instruction execution unit 101 outputs the read instruction to the encryption/decryption processing unit 103 (step S111). The encryption/decryption control unit 133 in the encryption/decryption processing unit 103 receives and decodes the instruction (step S112), and performs state transition based on the result of the result of the decoding (step S113).

Next, the encryption/decryption control unit 133 judges whether the received instruction matches the state in the state transition drawing. If the received instruction does not match (step S114), the process returns to step S105 and is repeated.

Next, if the encryption/decryption control unit 133 judges that the received instruction does match the state transition drawing (step S114), the input selection unit 136 selects a data input destination (step S115), the key selection unit 138 selects a key (step S116), the function selection unit 139 select a calculation circuit (step S117) and calculates (step S118), and the output selection unit 137 selects an output destination (step S119). Next, the process returns to step S105 and is repeated.

(3) Operations of the state transition process of the encryption/decryption control unit 133

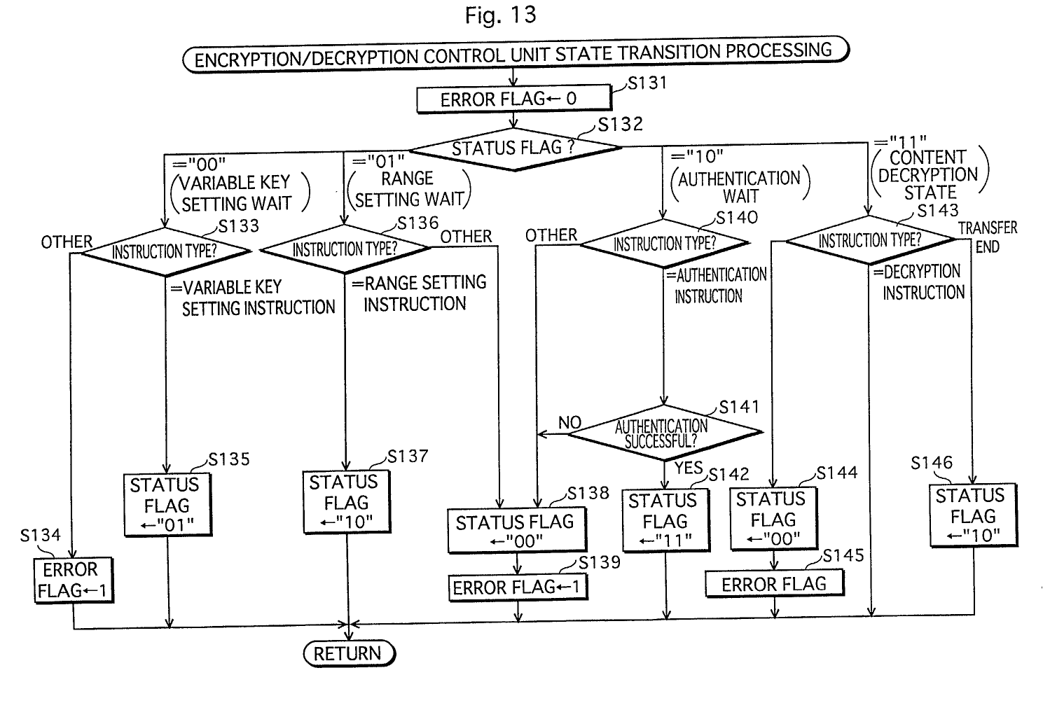

Operations of the state transition process of the encryption/decryption control unit 133 is described with use of the flowchart in FIG. 13. These operations are the details of step S113 shown in FIG. 12.

The encryption/decryption control unit 133 sets the error flag to “0” (step S131). Next, the encryption/decryption control unit 133 judges whether the status flag is set at one of “00”, “01”, “10”, and “11”.

When the status flag is “00” (step S132), the encryption/decryption control unit 133 further distinguishes the type of the instruction, and if the instruction is a variable key setting instruction (step S133), sets the status flag to “01” (step S135), and ends the state transition processing operation.

If the instruction is any other instruction (step S133), the encryption/decryption control unit 133 sets the error flag to “1” (step S134), and ends the state transition processing operation.

If the status flag is “01” (step S132), the encryption/decryption control unit 133, further distinguishes the type of the instruction, and if the instruction is a range setting instruction (step S136), sets the status flag to “10” (step S137), and ends the state transition processing operation.

If the instruction is any other instruction (step S136), the encryption/decryption control unit 133 sets the status flag to “00” (step S138), sets the error flag to “1” (step S139), and ends the state transition process operation.

When the status flag is “10” (step S132), the encryption/decryption control unit 133 further distinguishes the type of the instruction, and if the instruction is an authentication instruction (step S140) and the authentication result is success (step S141), sets the status flag to “11”, and ends the state transition processing operation.

Furthermore, if the instruction is an authentication instruction (step S140) and the authentication result is failure (step S141), the encryption/decryption control unit 133 sets the status flag to “00” (step S138), sets the error flag to “1” (step S139), and ends the state transition processing operation.

If the instruction is any other instruction (step S139), the encryption/decryption control unit 133 sets the status flag to “00” (step S138), sets the error flag to “1” (step S139), and ends the state transition processing operation.

When the status flag is “11” (step S132), the encryption/decryption control unit 133 further distinguishes the type of the instruction, and if the instruction is a decryption instruction (step S143), ends the state transition process operation.

Furthermore, if the encryption/decryption control unit 133 receives information showing the end of transfer (step S143), it sets the status flag to “10” (step S146), and ends the operations of the state transition process.

If the instruction is any other instruction (step S143), the encryption/decryption control unit 133 sets the status flag to “00” (step S144), sets the error flag to “1”, and ends the state transition process operation.

(4) Operations of the encryption/decryption processing unit 103

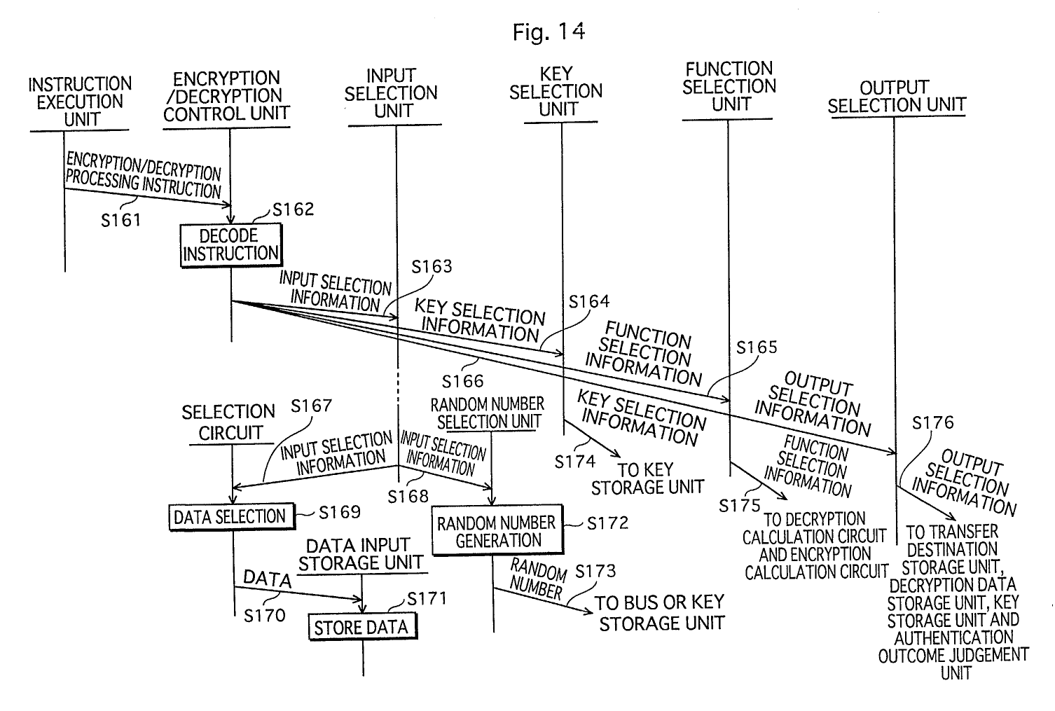

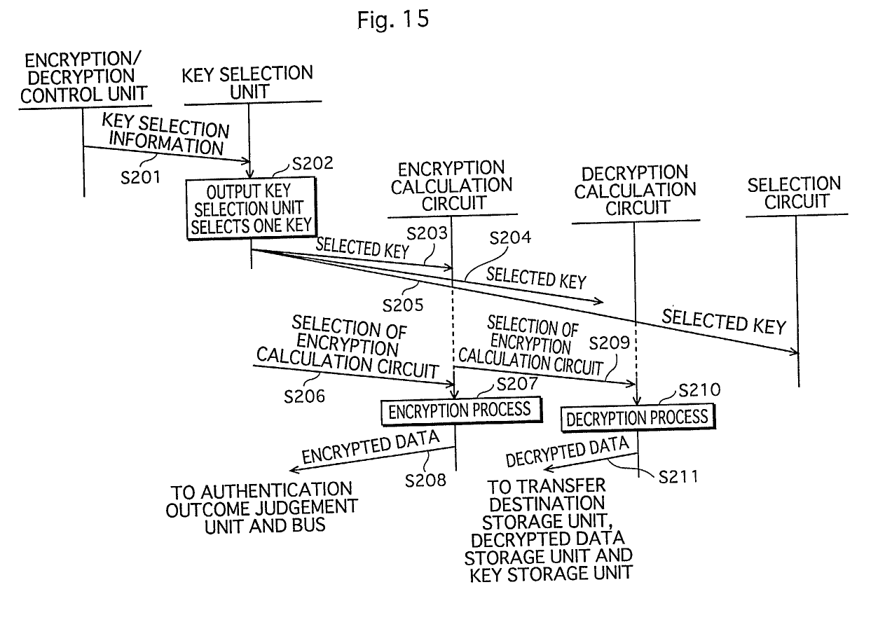

The operations of the elements composing the encryption/decryption processing unit 103 are described with use of the flowcharts shown in FIGS. 14 and 15.

On receiving a processing instruction regarding encryption/decryption from the instruction execution unit 101 (step S161), the encryption/decryption control unit 133 decodes the received instruction (step S162), outputs input selection information to the input selection unit 136 (step S163), key selection information to the key selection unit 138 (step S164), function selection information to the function selection unit 139 (step S165), and output selection information to the output selection unit 137 (step S166).

On receiving the input selection information (step S163), the input selection unit 136 outputs the received input selection information to the selection circuit 131 (step S167). The selection circuit 131 selects data to be input, based on the received input selection information (step S169), and outputs the selected data to the data input storage unit 132 (step S170). The data input storage unit 132 stores the received data (step S171).

Furthermore, the input selection unit 136 outputs input selection information showing random number generation to the random number generation unit 140 (step S168). The random number generation unit 140 generates a random number (step S172), and outputs the generated random number to the system bus 8 or the key storage unit 104 (step S173).

On receiving the key selection information (step S164), the key selection unit 138 outputs the received key selection information to the key storage unit 104 (step S174).

On receiving the function selection information (step S165), the function selection unit 139 outputs the received function selection information to the encryption calculation circuit 134 and the decryption calculation circuit 135 (step S175).

On receiving the output selection information (step S166), the output selection unit 137 outputs the received output selection information to the transfer destination address storage unit 107, the decrypted data storage unit 105, the key storage unit 104, and the authentication outcome judgement unit 106 (step S176).

Next, on the key selection unit 138 receiving the key selection information from the encryption/decryption control unit 133 (step S201), the output key selection unit 184 selects one key (step S202), outputs the selected key to the encryption calculation circuit 134 (step S203), the decryption calculation circuit 135 (step S204), and the selection circuit 131 (step S205).

The encryption calculation circuit 134 receives the selected key (step S203). Then, on receiving function selection information notifying selection of the encryption calculation circuit (step S206), the encryption calculation circuit 134 performs an encryption process, based on the selected key, to generate encrypted data (step S207), and outputs the generated encrypted data to the authentication outcome judgement unit 106 and the system bus 8 (step S208).

The decryption calculation circuit 135 receives the selected key (step S204). Then, on receiving function selection information notifying selection of the decryption calculation circuit (step S209), the decryption calculation circuit 135 performs a decryption process, based on the selected key, to generate decrypted data (step S210), and outputs the generated decrypted data to the transfer destination address storage unit 107, the decrypted data storage unit 105, and the key storage unit 104 (step S211).

(5) Operations of the decryption program

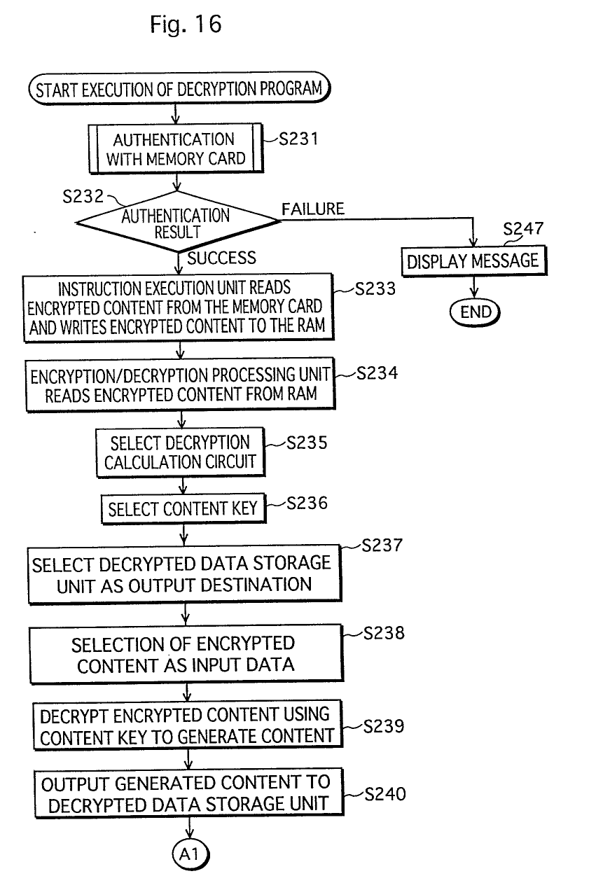

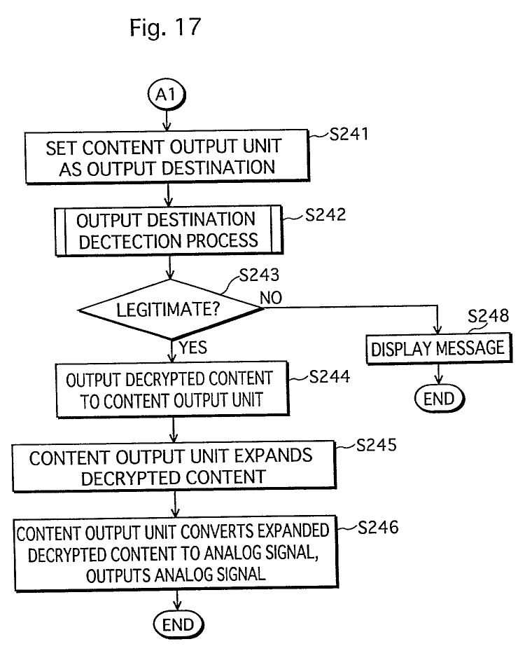

The operations of the execution of the decryption program according to the CPU 1 are described using to the flowcharts in FIGS. 16 and 17.

The encryption/decryption processing unit 103 performs authentication with the memory card 20 (step S231), and when authentication fails (step S232), the display unit displays a message showing that authentication has failed (step S147), and the process ends.

When authentication succeeds (step S232), the instruction execution unit 101 reads the encrypted content from the memory card 20 via the recording medium I/F unit 7, and writes the read content to the RAM 3 (step S233). The encryption/decryption processing unit 103 reads the encrypted content from the RAM 3 (step S234).

Next, the function selection unit 139 outputs function selection information selecting the decryption calculation circuit 135 (step S235). The key selection unit 138 outputs key selection information selecting the content key (step S236). The output selection unit 137 outputs the output selection information selecting the decrypted data storage unit 105 as the output destination (step S237). The input selection unit 136 outputs input selection information selecting the encrypted content as input data (step S238). Next, the decryption calculation circuit 135 decrypts the encrypted content using the content key to generate content (step S239), and outputs the generated content to the decrypted data storage unit 105 (step S240).

Next, the instruction execution unit 101 sets the address of the content output unit 2 as the output destination address in the transfer destination setting storage unit 161 (step S241). The transfer destination address detection unit,108 performs an output target address detection process (step S242), and if the output destination address is not legal (step S243), the display unit displays a message showing that the output target address is not legal (step S248) and the process ends.

If the output target address is legal (step S243), the CPU 1 outputs the decrypted content to the content output unit 2 (step S244). The content output unit 2 expands the decrypted content (step S245), and then converts the expanded content to an analog signal which it outputs to an external device (step S246).

(6) Memory card authentication operations

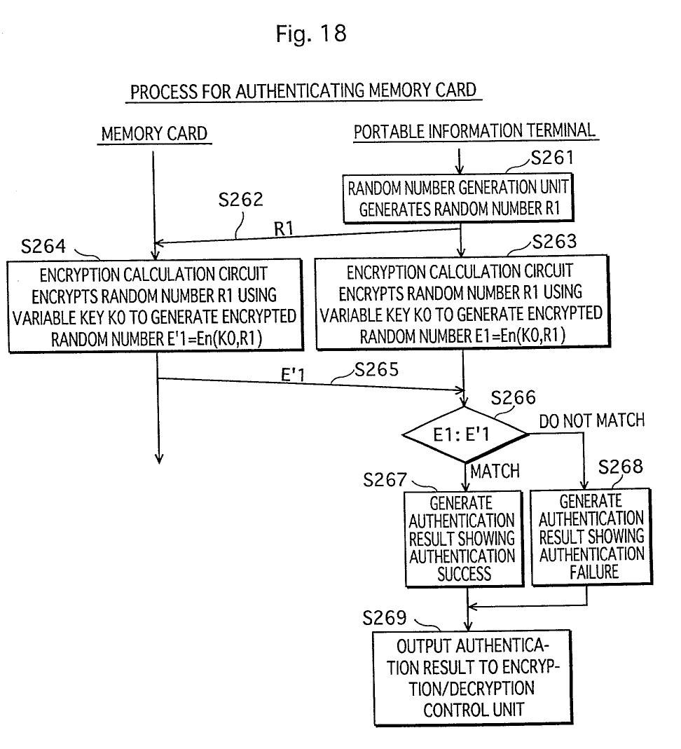

The following describes authentication operations of the memory card with use of the flowchart in FIG. 18. Note that these operations show the details of step S231 in the flowchart in FIG. 16.

The random number generation unit 140 generates a random number R1 (step S261). The CPU 1 outputs the generated random number R1 to the memory card 20 (step S262). The encryption calculation circuit 134 encrypts the random number R1 using a variable key K0 to generate an encrypted random number E1=En(K0, R1). Here, En (K, A) shows an encryption algorithm En applied to a plain text A using a key K (step S263).

The memory card 20 receives the random number R1 (step S262). The encryption/decryption processing unit of the memory card 20 encrypts R1 to generate an encrypted random number E1′=En(K0, R1) (step S264). Next, the memory card 20 outputs the generated encrypted random number E1′ (step S265).

The comparison circuit 173 of the authentication outcome judgement unit 106 compares the encrypted random number E1 and the encrypted random number E1′, and if the encrypted random numbers match (step S266), the comparison circuit 173 generates an authentication result showing authentication success (step S267). If the encrypted random numbers do not match (step S266), the comparison circuit 173 generates an authentication result showing authentication failure (step S268). Next, the comparison circuit 173 outputs the authentication result to the encryption/decryption control unit 133 (step S269).

(7) Operations of the transfer destination address detection unit 108

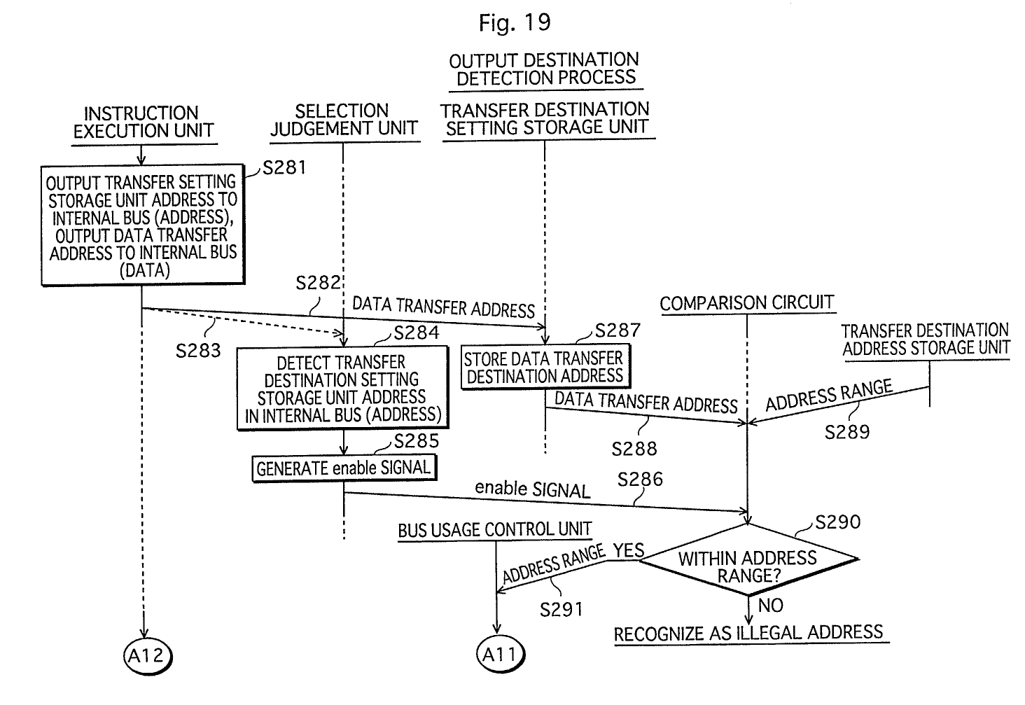

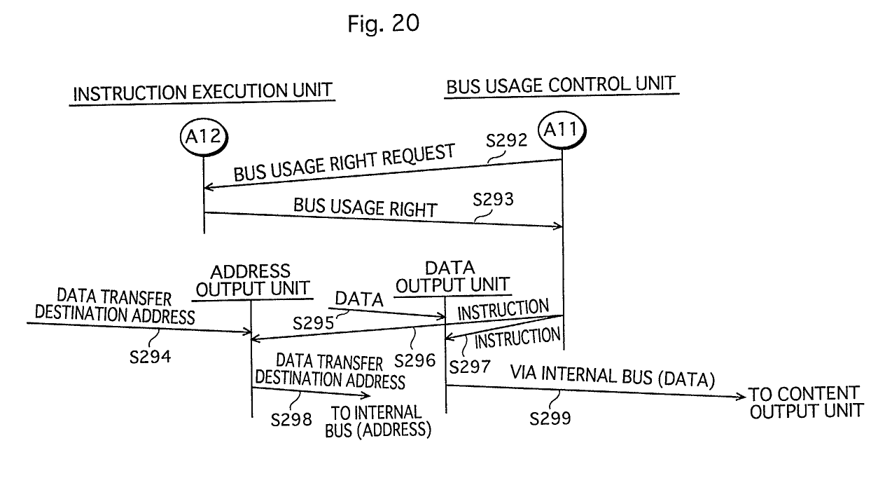

Operations of the transfer destination address detection unit 108 are described with use of the flowcharts shown in FIGS. 19 and 20. Note that these operations are details of step S242 in the flowchart in FIG. 17.

The instruction execution unit 101 outputs the address of the transfer destination setting storage unit 161 to the internal bus address line, and outputs the data transfer destination address to the internal bus data line (step S281).

The transfer destination setting storage unit 161 receives the data transfer destination address (step S282), and stores the received data transfer destination address internally (step S287).

The selection judgement unit 162 detects the address of the transfer destination setting storage unit 161 in the internal bus address line (step S283 to S284), and on detecting the address, generates an enable signal (step S285) and outputs the generated enable signal to the comparison circuit 163 (step S286).

The comparison circuit 163 obtains the data transfer destination address from the transfer destination setting storage unit 161 (step S288), and obtains the address range from the transfer destination address storage unit 107 (step S289).

On obtaining the enable signal (step S286), the comparison circuit 163 judges whether the data transfer destination address is within the address range, and when the address is not within the address range (step S290), recognizes the address as being illegal. In this case decrypted data is not output to an external device.

When the address is within the address range (step S290), the comparison circuit 163 outputs information to the bus usage control unit 164 showing that the address is within the address range (step S291).

The bus usage control unit 164 outputs a request for a bus usage right to the instruction execution unit 101 (step S292), and receives the bus usage right from the instruction execution unit 101 (step S293).

Next, the bus usage control unit 164 outputs and instruction to the address output unit 165 (step S296), and outputs an instruction to the data output unit 166 (step S297). The address output unit 165 obtains the data transfer destination address from the transfer destination setting storage unit 161 (step S294), and outputs the data transfer destination address to the internal bus (address line) (step S298). The data output unit 166 obtains decrypted data (step S295), and outputs the decrypted data to the content output unit 2 via the internal bus (data line) (step S299).

(8) Operations of the variable key updating program

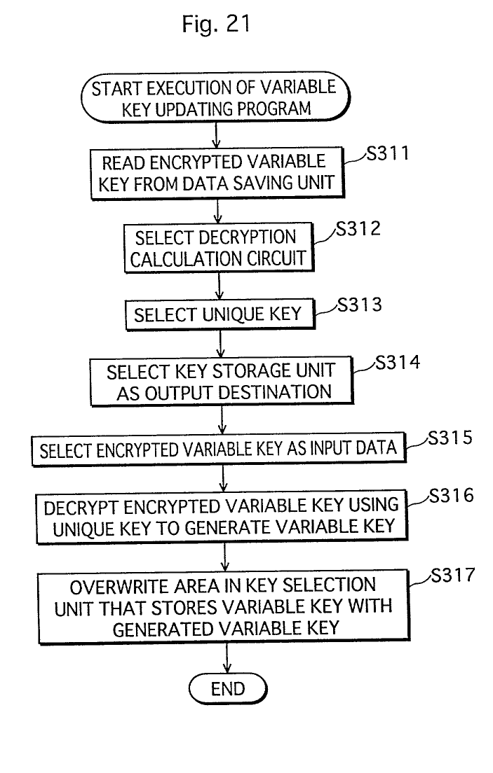

Operations of the variable key update program by the CPU 1 are described with use of the flowchart in FIG. 21.

The instruction execution unit 101 reads the encrypted variable key from the data saving unit 4 (step S311).

Next, the function selection unit 139 outputs function selection information that selects the decryption calculation circuit 135 (step S312). The key selection unit 138 outputs key selection information specifying the unique key (step S313). The output selection unit 137 outputs output selection information specifying the key storage unit 104 as the output destination (step S314). The input selection unit 136 outputs input selection information specifying the encrypted variable key as the input data (step S315). Next, the decryption calculation circuit 135 decrypts the encrypted variable key using the unique key, to generate the variable key (step S316), and overwrites the variable key being stored in the key storage area 182 of the key storage unit 104 with the generated variable key (step S317).

(9) Operations of the transfer destination address range updating program

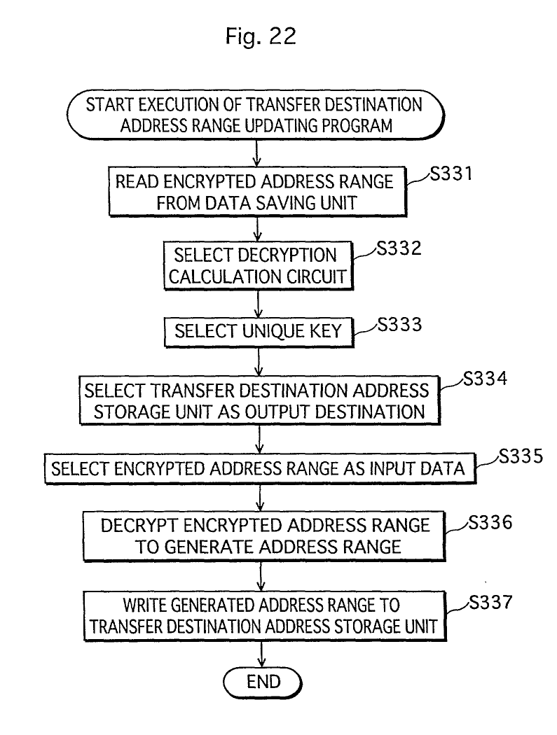

Operations of the transfer destination address range update program by the CPU l are described with use of the flowchart in FIG. 22.

The instruction execution unit 101 reads the encrypted address range from the data saving unit 4 (step S331).

Next, the function selection unit 139 outputs function selection information that selects the decryption calculation circuit 135 (step S332). The key selection unit 138 outputs key selection information that selects the unique key (step S333). The output selection unit 137 outputs output selection information that selects the transfer destination address storage unit 107 (step S334). The input selection unit 136 outputs input selection information that selects the encrypted address range as input data (step S335). Next, the decryption calculation circuit 135 decrypts the encrypted address range using the unique key, to generate the address range (step S336), and overwrites the address range in the transfer destination address storage unit 107 (step S337).

1.4 Other

(1) The above-described operations are the same when encrypted content is input through the external input/output I/F unit 5.

(2) In the above-described transfer destination address detection unit 108, it is assumed that the bus usage control unit 164 receives a bus usage right from the instruction execution unit 101 before transferring data.

However, a structure in which the instruction language executed by the instruction execution unit 101 supports a special instruction language that performs an operation for reading data from the decrypted data storage unit 105 and temporarily storing the data in a special area other than a general purpose register in the instruction execution unit 101, and a device that monitors the output target address of the data is provided in the instruction execution unit 101 would also be logically equivalent to the invention of the present application.

(3) Security can be increased by encrypting instructions output by the instruction execution unit 101 to the encryption/decryption control unit 133.

To realize this the above-described device may be operated as follows.

Specifically, the instruction execution unit 101 encrypts the encryption/decryption process instruction with the variable key unique to the CPU 1 which is stored in the data input storage unit 132 of the encryption/decryption processing unit 103. The decryption calculation circuit 135 decrypts the encrypted instruction. Next, the decrypted instruction is stored in the decrypted data storage unit 105, and an address corresponding to an instruction input register in the encryption/decryption control unit 133 is set in the transfer destination setting storage unit 161 which specifies the transfer destination address of the data.

As long as this address is set so as to be within the address range stored in the transfer destination address storage unit 107, a decrypted instruction can be input into the encryption/decryption control unit 133.

(4) As described above, authentication and content transfer can only take place after the state machine provided in the encryption/decryption control unit 133 undergoes the process for setting the variable key, the transfer destination address range and soon. Therefore, illegal transfer of content by software at initialization while the variable key, the transfer destination address range, and so on are unset can be avoided.

(5) In the portable information terminal 10 the recording medium I/F unit 7 is positioned external to the CPU 1 as shown in FIG. 2, but positioning the recording medium I/F unit 7 inside the CPU 1 and integrating the two does not effect the content of the invention of the present application.

2. Second Embodiment

A program setting system 50b is described as another embodiment of the present invention.

The object of the program setting system 50b is to prevent illegal settings of the encryption/decryption processing unit by a computer program.

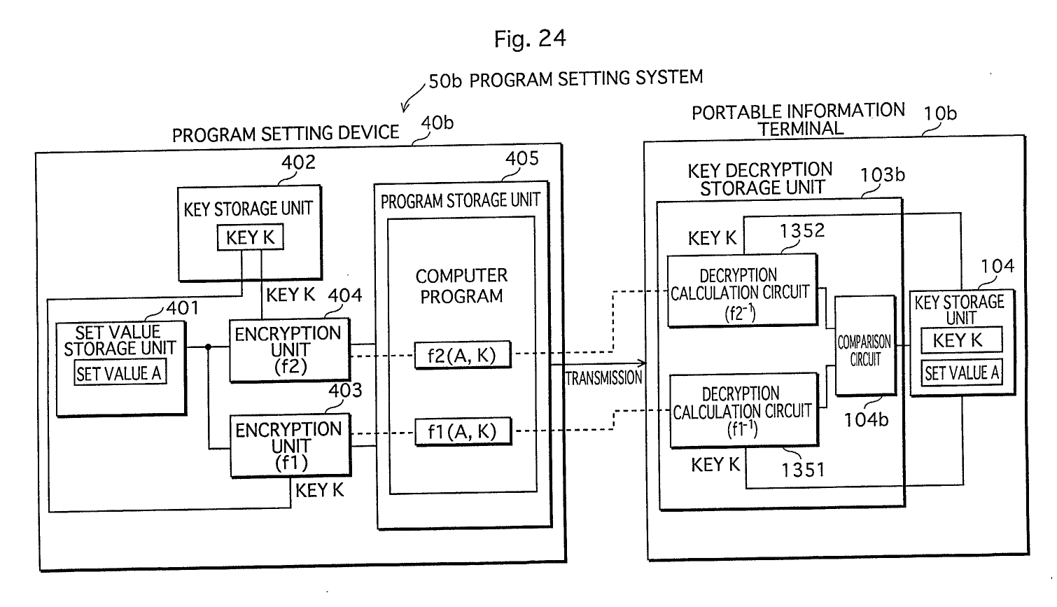

As FIG. 24 shows, the program setting system 50b is composed of a program setting device 40b and a personal information terminal 10b.

The personal information terminal 10b decrypts and outputs encrypted content recorded in a memory card, as the portable information terminal 10 does, by operating following computer programs.

The program setting device 40b generates the computer programs that operate in the personal information terminal 10b. Here, a user who stores a computer program in the personal information terminal 10b connects the program setting device 40b and the personal information terminal 10b through a cable 32. Note that this connection may be made through a communication line, the Internet, or the like. Next, the program setting device 40b transmits the generated computer program to the personal information terminal 10b.

2.1 Structure of program setting device 40b

As FIG. 24 shows, the program setting device 40b is composed of a set value storage unit 401, a key storage unit 402, an encryption unit 403, an encryption unit 404, a program storage unit 405, and a transmission unit (not illustrated).

Specifically, the program setting device 40b is a computer system composed of a microprocessor, a ROM, a RAM, a hard disk unit, a keyboard, a mouse, a LAN connection unit, and so on. Computer programs are stored in the RAM and the hard disk unit. The program setting device 40b achieves its functions by the microprocessor operating following the computer programs.

(1) Set value storage unit 401

The set value storage unit 401 pre-stores a set value A. As an example, the set value A may be any of the variable key, the memory card common key, . . . , the content key, and the content unit output key shown in FIG. 7. These keys are keys that are to be stored in the corresponding areas in the key storage unit 104. Furthermore, another example of the set value A is the transfer destination address range to be stored in the transfer destination address storage unit 107.

(2) Key storage unit 402

The key storage unit 402 pre-stores a key K. Specifically, the key K is 56-bit key information.

(3) Program storage unit 405

The program storage unit 405 pre-stores a computer program. Here, as one example, the computer program includes an instruction for decrypting and outputting encrypted content that is recorded on the memory card, in the personal information terminal 10b.

(4) Encryption unit 403

The encryption unit 403 has an encryption algorithm f1. Specifically, the encryption algorithm f1 conforms to DES encryption.

The encryption unit 403 reads the key K from the key storage unit 402, reads the set value A from the set value storage unit 401, and applies the algorithm f1 to the set value A using the key K as the key, to generate a cipher text f1 (A, K). Here, a cipher text obtained by applying an algorithm F to a plain text M using the key K is expressed as F(M, K). Next, the encryption unit 403 writes the generated cipher text f1(A, K) to a predetermined position in the computer program stored in the program storage unit 405.

(5) Encryption unit 404

The encryption unit 404 has an encryption algorithm f2. Specifically, the encryption algorithm f2 conforms to DES encryption. The encryption algorithms f1 and f2 differ in that their S box values, a parameter in DES encryption, differ.

The encryption unit 404, in the same manner as the encryption unit 403, reads the key K from the key storage unit 402, reads the set value A from the set value storage unit 401, and applies the algorithm f2 to the set value A using the key K as the key, to generated a cipher text f2(A, K). Next, the encryption unit 403 writes the generated cipher text f2(A, K) to a predetermined position in the computer program stored in the program storage unit 405.

(6) Transmission unit

The transmission unit reads the computer program in which the cipher text f1(A, K) and the cipher text f2(A, K) have been written, and transmits the read program to the personal information terminal 10b.

2.2 Structure of the personal information terminal 10b

The personal information terminal 10b has a similar structure to that of the portable information terminal 10. Here, the description focus on the differences while omitting the structure that is the same.

The personal information terminal 10b has a encryption/decryption processing unit 103b instead of the encryption/decryption processing unit 103.

(1) Key storage unit 104

The key storage unit 104 pre-stores the key K. Here the key K is the same key information as that stored in the key storage unit 402 of the program setting device 40b.

(2) Data saving unit 4

The data saving unit 4 receives the computer program from the program setting device 40b via the cable 32, the external input/output I/F unit 5, and the system bus 8, and stores the received program.

(3) Encryption/decryption processing unit 103b

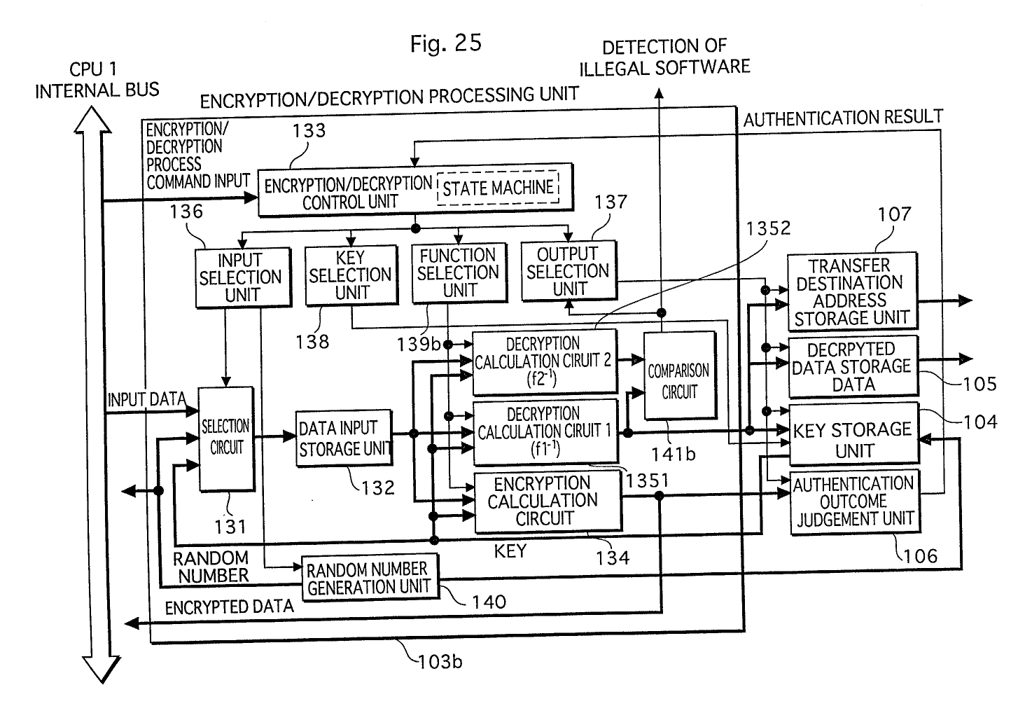

As FIG. 25 shows, the encryption/decryption processing unit 103b has a similar structure to that of the encryption/decryption processing unit 103, but in addition to the decryption calculation circuit 135 the encryption/decryption processing unit 103b is further composed of a decryption calculation circuit 1351 and a decryption calculation circuit 1352, as well as a comparison circuit 141b.

<Data input storage unit 132>

The data input storage unit 132 stores the cipher text f1 (A, K) that is included in the computer program that is stored in the data saving unit 4. Furthermore, the data input storage unit 132 also stores the cipher text f2(A, K).

<Decryption calculation circuit 1351>

The decryption calculation circuit 1351 has a similar construction to that of the decryption calculation circuit 135. The following description focuses on the differences.

The decryption calculation circuit 1351 has a decryption algorithm f1⁻¹ that is an inverse transformation of the encryption algorithm f1.

The decryption calculation circuit 1351 reads the cipher text f1(A, K) from the data input storage unit 132, reads the key K from the key storage unit 104, applies the decryption algorithm f1⁻¹ to the cipher text f1(A, K) using the read key K, to generate a decrypted value d1=f1⁻¹(f1 (A, K), K), and outputs the generated decrypted value dl to the comparison circuit 141b.

The decryption calculation circuit 1351 outputs the generated decrypted value d1 to the key storage unit 104, according to an instruction by the output selection unit 137.

<Key storage unit 104>

The key storage unit 104 receives the decrypted value d1 from the decryption calculation circuit 1351, and stores one of the pieces of key information.

<Decryption calculation circuit 1352>

The decryption calculation circuit 1351 and the decryption calculation circuit 1352 have the same specifications in regard to the key that is input and the bit length of the encryption data, however the two circuits differ in the encryption functions that they use.

The decryption calculation circuit 1352 has a similar structure to that of the decryption calculation circuit 135. The following describes the differences with the decryption calculation circuit 135.

The decryption calculation circuit 1352 has a decryption algorithm f2⁻¹ that is an inverse transformation of the encryption algorithm f2.

The decryption calculation circuit 1352 reads the cipher text f2(A, K) from the data input storage unit 132, reads the key K from the key storage unit 104, applies the decryption algorithm f2⁻¹ to the cipher text f2(A, K) using the read key K, to generate a decrypted value d2=f2⁻¹(f2 (A, K), K), and outputs the generated decrypted value d2 to the comparison circuit 141b.

<Comparison circuit 141b>

The comparison circuit 141b receives the decrypted value d1 from the decryption calculation circuit 1351, and receives the decrypted value d2 from the decryption calculation circuit 1352. Next, the comparison circuit 141b judges whether the decrypted values d1 and d2 match, and outputs judgement information showing whether or not the decrypted values d1 and d2 match to the instruction execution unit 101.

Furthermore, if the decrypted values d1 and d2 match, the comparison circuit 141 outputs an enable signal to the output selection unit 137.

<Output selection unit 137>

The output selection unit 137 outputs decrypted data to the output selection unit 137 only when the enable signal is effective.

(4) Instruction execution unit 101

The instruction execution unit 101 receives the judgement information from the comparison circuit 141b, and continues processing if the received judgement information shows that the decrypted values d1 and d2 match.

If the received judgement information shows that the decrypted values d1 and d2 do not match, the instruction execution unit 101 suspends processing. In this case, the instruction execution unit 101 displays a message showing notification to this effect on the display unit.

2.3 Operations of the program setting device 40b and the personal information terminal 10b

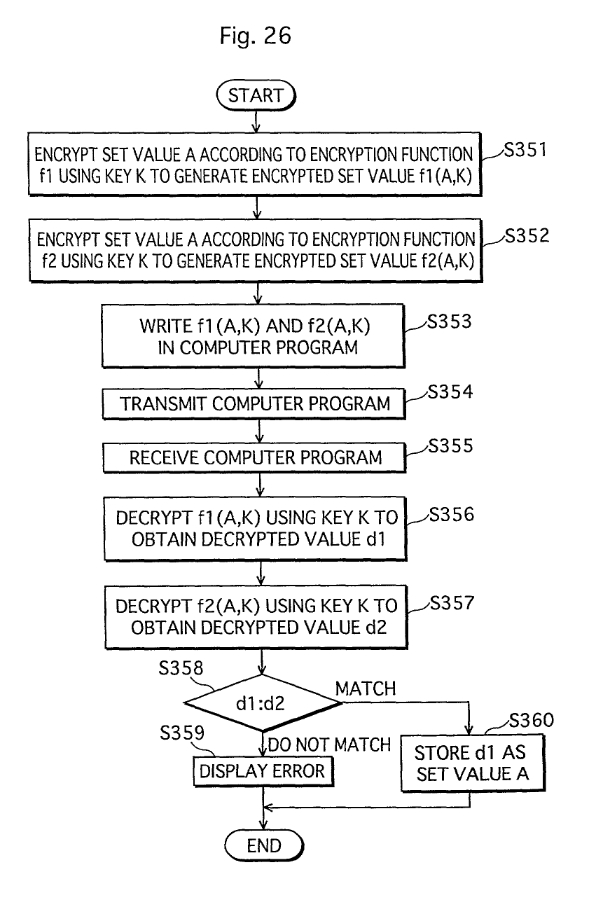

The following describes operations of the program setting device 40b and the personal information terminal 10b with use of the flowchart in FIG. 26.

The encryption unit 403 reads the key K from the key storage unit 402, reads the set value A from the set value storage unit 401, and applies the encryption algorithm f1 to the set value A using the key K, to generate a cipher text f1 (A, K) (step S351). The encryption unit 404 reads the key K from the key storage unit 402, reads the set value A from the set value storage unit 401, and applies the encryption algorithm f2 to the set value A using the key K, to generate a cipher text f2 (A, K) (step S352).

Next, the encryption unit 403 writes the generated cipher text f1 (A, K) to a predetermined position in the computer program that is stored in the program storage unit 405, and the encryption unit 404 writes the generated cipher text f2(A, K) to another predetermined position in the computer program that is stored in the program storage unit 405 (step S353).

Next, the transmission unit reads the computer program in which the cipher text f1(A, K) and the cipher text f2(A, K) have been written, from the program storage unit 405, and transmits the read computer program to the personal information terminal 10b (step S354).

Next, the data saving unit 4 of the personal information terminal 10b receives the computer program from the program setting device 40b via the cable 32, the external input/output I/F unit 5, and the system bus 8, and stores the received computer program (step S355).

Next, the decryption calculation circuit 1351 reads the cipher text f1 (A, K) from the data input storage unit 132, reads the key K from the key storage unit 104, applies the decryption algorithm f1⁻¹ to the cipher text f1(A, K) using the key K, to generate a decrypted value d1=f1⁻¹(fi (A, K), K), and outputs the generated decrypted value d1 to the comparison circuit 141b (step S356).

The decryption calculation circuit 1352 reads the cipher text f2(A, K) from the data input storage unit 132, reads the key K from the key storage unit 104, applies the encryption algorithm f2⁻¹ to the cipher text f2(A, K) using the key K, to generate a decrypted value d2=f2⁻¹(f2 (A, K), K), and outputs the generated decrypted value d2 to the comparison circuit 141b (step S357).

The comparison circuit 141b receives the decrypted value d1 from the decryption calculation circuit 1351, receives the decrypted value d2 from the decryption calculation circuit 1352, judges whether the decrypted values d1 and d2 match, and outputs judgement information showing whether or not the decrypted values d1 and d2 match to the instruction execution unit 101. If the judgement information shows that the decrypted values d1 and d2 match (step S358), the instruction execution unit 101 continues processing, the decryption calculation circuit 1351 outputs the decrypted value d1 to the key storage unit 104, and the key storage unit 104 stores the decrypted value d1 as key information (step S360).

If the judgement information shows that the decrypted values d1 and d2 do not match (step S358), the instruction execution unit 101 display a message showing notification to that effect on the display unit, and suspends processing (step S359).

2.4 Conclusion

The object of the program setting system is to make it difficult for illegal software that has been made by tampering with legal software to execute settings that are different to the legal settings without accurately grasping the key K.

As FIG. 25 shows, when setting the value used in the software, specifically when setting the set value A in the personal information terminal 10b in the above-described embodiment, the value is encrypted using two or more types of encryption algorithms, and then decrypted in the personal information terminal 10b. By comparing the results of decryption of the two or more encryptions to see if they contradict, it is judged whether the software is illegal or not.

If illegal software tampers with legal software and tries to change the transfer destination address range, it is necessary for the illegal software to set the transfer destination address range to the two types of encrypted states, the same as the legal software. However, the it is impossible to satisfy the equality in the comparison circuit 141b without knowing the two types of functions. As a result, the output selection unit 137 does not output an output selection signal, and a decrypted illegal transfer destination address range is not sent.

2.5 Other modifications

The following describes a program setting system 50c as a modification of the program setting system 50b.

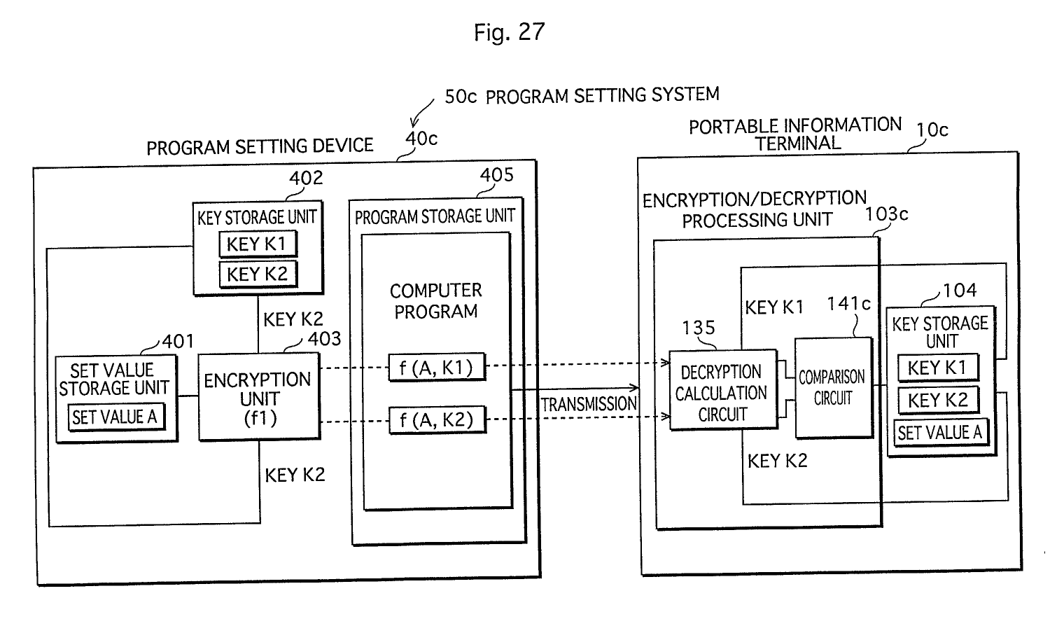

As FIG. 27 shows, the program setting system 50c is composed of a program setting device 40c and a portable information terminal 10c which have a similar structure to the program setting device 40b and the portable information terminal 10b. The following description focuses on the differences between the program setting device 40c and the portable information terminal 10c and the program setting device 40b and the portable information terminal 10b.

(1) Structure of program setting device 40c

As FIG. 27 shows, the program setting device 40c is composed of a set value storage unit 401, a key storage unit 402, a encryption unit 403, a program storage unit 405, and a transmission unit (not illustrated).

<Key storage unit 402>

The key storage unit 402 pre-stores a key K1 and key K2. Specifically, the keys K1 and K2 are each 56-bit key information.

<Encryption unit 403>

The encryption unit 403 has an encryption algorithm f1. Specifically, the encryption algorithm f1 conforms to DES encryption.

The encryption unit 403 reads the keys K1 and K2 from the key storage unit 402, and reads the set value A from the set value storage unit 401. Next, the encryption unit 403 applies the encryption algorithm f1 to the set value A using the key K1 as a key, to generate a cipher text f1(A, K1). Furthermore, the encryption unit 403 applies the encryption algorithm f1 to the set value A using the key K2 as a key, to generate a cipher text f1(A, k2). Next, the encryption unit 403 writes the generated cipher texts f1(A, K1) and f1(A, K) to respective predetermined positions in the computer program stored in the program storage unit 405.

(2) Structure of personal information terminal 10c

The personal information terminal 10c has a encryption/decryption processing unit 103c instead of the encryption/decryption processing unit 103b.

<Key storage unit 104>

The key storage unit 104 stores a key K1 and a key K2. The keys K1 and K2 are the same keys K1 and K2 that the key storage unit 402 stores.

<Encryption/decryption processing unit 103c>

As FIG. 27 shows, the encryption/decryption processing unit 103c has a similar structure to that of the encryption/decryption processing unit 103b, but has a decryption calculation circuit 135 instead of the decryption calculation circuit 1351 and the decryption calculation circuit 1352, and a comparison circuit 141c instead of the comparison circuit 141b.

The data input storage unit 132 stores the cipher texts f1(A, K1) and f1(A, K2).

The decryption calculation circuit 135 has a decryption algorithm f1⁻¹ that is an inverse transformation of the encryption algorithm f1. The decryption calculation circuit 135 reads the cipher text f1(A, K1) and the cipher text f1(A, K2) from the data input storage unit 132, and reads the keys K1 and K2 from the key storage unit 402. The encryption unit 403 applies the encryption algorithm f1⁻¹ to the cipher texts f1(A, K1) and f1(A, K2) using the read keys K1 and K2 as a key, to generate respectively a decrypted value d1=f1⁻¹(f1(A, K1), K1) and a decrypted value d2=f1⁻¹(f1(A, K2), K2), and outputs the generated decrypted values d1 and d2 to the comparison circuit 141c.

The comparison circuit 141c receives the decrypted value d1 and the decrypted value d2 from the decryption calculation circuit 135. Next, the comparison circuit 141c judges whether or not the decrypted value d1 and the decrypted value d2 match, and outputs judgement information showing whether the decrypted values d1 and d2 match via the internal bus to the instruction execution unit 101. Furthermore, if the decrypted values d1 and d2 match, the comparison circuit 141c outputs an enable signal to the output selection unit 137.

(3) Operations of program setting device 40c and portable information terminal 10c

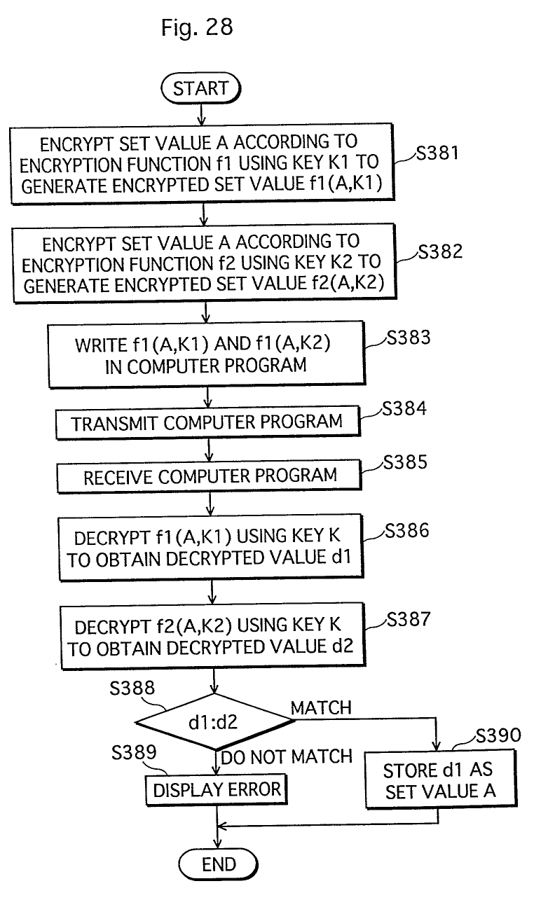

The following describes operations of the program setting device 40c and the portable information terminal 10c with use of the flowchart in FIG. 28.

The encryption unit 403 applies the encryption algorithm f1 to the set value A using the key K1 as a key, to generate a cipher text f1(A, K1) (step S381), and applies the encryption algorithm f1 to the set value A using the key K2 as a key, to generate a cipher text f1(A, K2) (step S382). Next, the encryption unit 403 writes the generated cipher texts f1(A, K1) and f1(A, K2) to respective predetermined positions in the computer program stored in the program storage unit 405 (step S383).

Next, the transmission unit reads the computer program from the program storage unit 405, and transmits the read computer program to the portable information terminal 10c (step S384).

The data saving unit 4 in the portable information terminal 10c receives the computer program from the program setting device 40c via the cable 32, the external input/output I/F unit 5, and the system bus 5, and stores the received computer program (step S385).

Next, the decryption calculation circuit 135 applies the decryption algorithm f⁻¹ to the cipher text f1(A, K1) using the key Ki, to generate a decrypted value d1=f1⁻¹ (f1(A, K1), K1), and outputs the generated decrypted value d1 to the comparison circuit 141c (step S386).

Next, the decryption calculation circuit 135 applies the decryption algorithm to the cipher text f1(A, K2) using the key K2, to generate a decrypted value d2=f1⁻¹(f1(A, K2), K2), and outputs the generated decrypted value d2 to the comparison circuit 141c (step S387).

Next, the comparison circuit 141c receives the decrypted values d1 and d2 from the decryption calculation circuit 135, judges whether the decrypted values d1 and d2 match, and outputs judgement information showing whether the decrypted values d1 and d2 match via the internal bus to the instruction execution unit 101. When the judgement information shows that the decrypted values d1 and d2 match (step S388), the instruction execution unit 101 continues processing, the decryption calculation circuit 135 outputs the decrypted value d1 to the key storage unit 104, and the key storage unit 104 stores the decrypted value d1 as key information (step S390).

When the judgement information shows that the decrypted values d1 and d2 do not match (step S388), the instruction execution unit 101 displays a message showing notification to that effect on the display unit, and suspends processing (step S389).

(4) Conclusion

As described above, instead of two types of functions two types of keys may be provided, and data that is encrypted in two ways input. In such a case, one decryption calculation circuit is sufficient, rather than the two in FIG. 25, if the keys are switched between. Here, there may be two registers to store the decryption results compared in the comparison circuit 141.

Note that three or more encryption functions or three or more keys may be provided. In such a case it is sufficient to provide two registers to store the decryption results that are compared in the comparison circuit 141. This is because even if there are three or more pieces of decrypted data, one piece of decrypted data can be input into the registers at a time, compared two at a time in the comparison circuit, and the process suspended when one pair does satisfy the equality.

If the equality is not satisfied in the comparison circuit 141 it is clear that the software is illegal, thus the device may be structured so that when the comparison circuit gives a negative judgement, the device overall is initialized, and a request is made to start over again from performing initialization settings of the software. Furthermore, a request may be made to the user to update the programs saved in the data saving unit 4 with a different programs. Furthermore, a request may be made to input a random number from the random number generation unit 140 to the key storage unit 104, reset the value of the variable key unique to the CPU 1 to a new value, and to re-encrypt the program stored in the data saving unit with the new key.

This means that the effort required to make a brute force attack on the keys can be greatly increased.

3. Third Embodiment

The following describes a portable information terminal 10d as yet another embodiment of the present invention.

In order to further strengthen prevention of illegal use of content, the portable information terminal 10d has a structure in which the encryption/decryption unit performs authentication with each module that is associated with content transmission. Specifically, the CPU, the content output unit and the memory card store a common key, and mutual confirmation of the common key is performed to mutually verify whether the modules are legitimate.

However, using a common key of the same value continuously in this case will lead to a great amount of damage if the common key is exposed. Therefore, is desirable to have a function that enables the key to be updated safely to maintain long-term safety in transfer of content.

In order to achieve this, the portable information terminal 10d safely shares the common key used in common key encryption, and further updates the key.

Note that the portable information terminal 10d has a similar structure as the portable information terminal 10. The following description focuses on the differences between the portable information terminal 10d and the portable information terminal 10.

3.1 Structure of the portable information terminal 10d

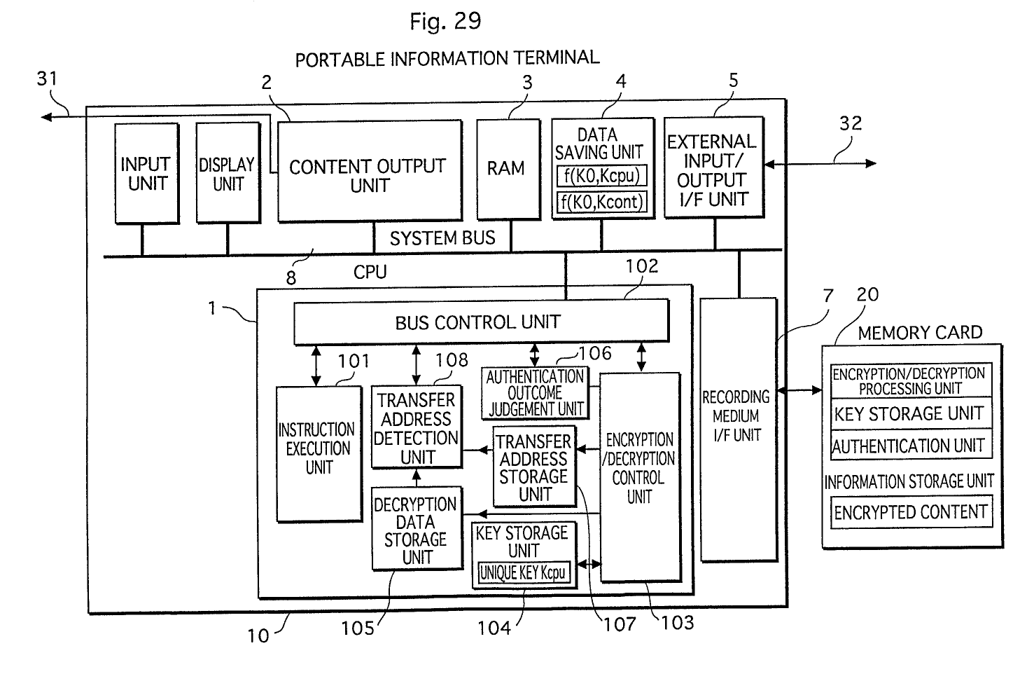

As FIG. 29 shows, the portable information terminal 10d has a content output unit 2d instead of the content output unit 2.

(1) Key storage unit 104

The key storage unit 104 further stores a unique key Kcpu that is key information unique to the CPU 1.

(2) Data saving unit 4

The data saving unit 4 further pre-stores an encrypted key f(K0, Kcpu) and an encrypted key f(K0, Kcont).

The encrypted key f(K0, Kcpu) is encrypted information obtained by applying the encryption algorithm f to the common key K0 using the unique key Kcpu as the key.

Here, the common key K0 is common key information that is stored in both the CPU 1 and the content output unit 2d, and is the initial value of the common key.

The encrypted key f(K0, Kcont) is encrypted information obtained by applying the encryption algorithm f to the common key K0 using the unique key Kcont as the key. Here, the unique key Kcont is key information that is unique to the content output unit 2d.

The encrypted key f(K0, Kcpu) and the encrypted key (K0, Kcpu) are transferred to the CPU1 and the content output unit 2d respectively, and decrypted as the initial value K0 of the common key.

(3) Content output unit 2d

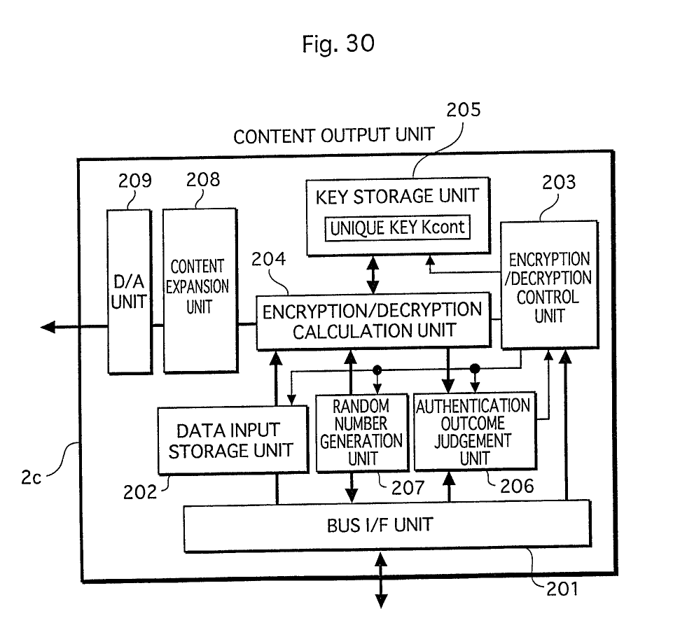

As FIG. 30 shows, the content output unit 2d is composed of a bus I/f unit 201, a data input storage unit 202, an encryption/decryption calculation unit 204, a key storage unit 205, an authentication outcome judgement unit 206, a random number generation unit 207, a content expansion unit 208, and a D/A unit 209.

<Bus I/f unit 201>

The bus I/f unit 201 is a module for performing transmission/reception of data with the CPU 1, via the system bus 8.

The bus I/F unit 201 receives data from the CPU 1 that is to be encrypted/decrypted, encryption/decryption control signals, and data used in authentication with the CPU 1.

THE bus I/f unit 201 outputs the data that is to be encrypted/decrypted to the data input storage unit 202, outputs the encryption/decryption control signals to the 203, and outputs the data used in authentication with the CPU 1 to the authentication outcome judgement unit 206.

<Data input storage unit 202>

The data input storage unit 202 is composed of an area for storing data that is to be encrypted/decrypted.

<Encryption/decryption control unit 203>

The encryption/decryption control unit 203 receives an encryption/decryption control signal from the CPI 1 via the bus I/f unit 201, judges, based on an instruction included in the control signal, the content of the process to be executed in the encryption/decryption calculation unit 204, and selects input data to be encrypted/decrypted from amongst the data input storage unit 202, the random number generation unit 207, and the key storage unit 205.

Next, the encryption/decryption control unit 203 selects the key stored in the key storage unit 205, and controls the encryption/decryption calculation unit 204 so that the encryption/decryption calculation unit 204 calculates.

When the encryption/decryption calculation unit 204 has finished calculating, the encryption/decryption control unit 203 specifies one of the content expansion unit 208, the key storage unit 205, and the authentication outcome judgement unit 206 as an output destination for the calculation result.

<Encryption/decryption calculation unit 204>

The encryption/decryption calculation unit 204 has an encryption algorithm f and a decryption algorithm f⁻¹.

The encryption/decryption calculation unit 204, under the control of the encryption/decryption control unit 203, receives the key from the key storage unit 205, input data to be encrypted/decrypted from one of the data input storage unit 202, the random number generation unit 207, and the key storage unit 205. The encryption/decryption calculation unit 204 applies one of the encryption algorithm f and the decryption algorithm f⁻¹ to the input data using the key, and outputs the calculation result to one of the content expansion unit 208, the key storage unit 205, and the authentication outcome judgement unit 206.

<Key storage unit 205>

The key storage unit 205 is a module for storing the key used by the encryption/decryption calculation unit 204.

As with the key storage unit 104, the key information stored in the key storage unit 205 can only be accessed from the instruction execution unit 101 after encryption/decryption calculation.

The key storage unit 104 pre-stores the unique key Kcont.

<Authentication outcome judgement unit 206>

The authentication outcome judgement unit 206 has the same structure to the authentication outcome judgement unit 106, and is a module for executing authentication using a random number, such as shown in FIG. 18.

<Random number generation unit 207>

The random number generation unit 207 generates a random number under the control of the 203, and outputs the generated random number to the unit specified by the encryption/decryption control unit 203.

<Content expansion unit 208>

The content expansion unit 208 receives the decrypted compressed content from the encryption/decryption calculation unit 204, expands the compressed content, and outputs the expanded content to the D/A unit 209.

<D/A unit 209>

The D/A unit 209 receives the expanded content from the content expansion unit 208, and converts the received content to an analog signal which it then outputs.

3.2 Operations of the portable information terminal 10d

The following describes operations of the CPU 1 and the content output unit 2d of the portable information terminal l0d.

(1) Operations of the CPU 1 and the content output unit 2d in key sharing

The following describes operations of the CPU 1 and the content output unit 2d in key sharing, and in particular operations for setting the initial value K0.

<Operations of the CPU 1>

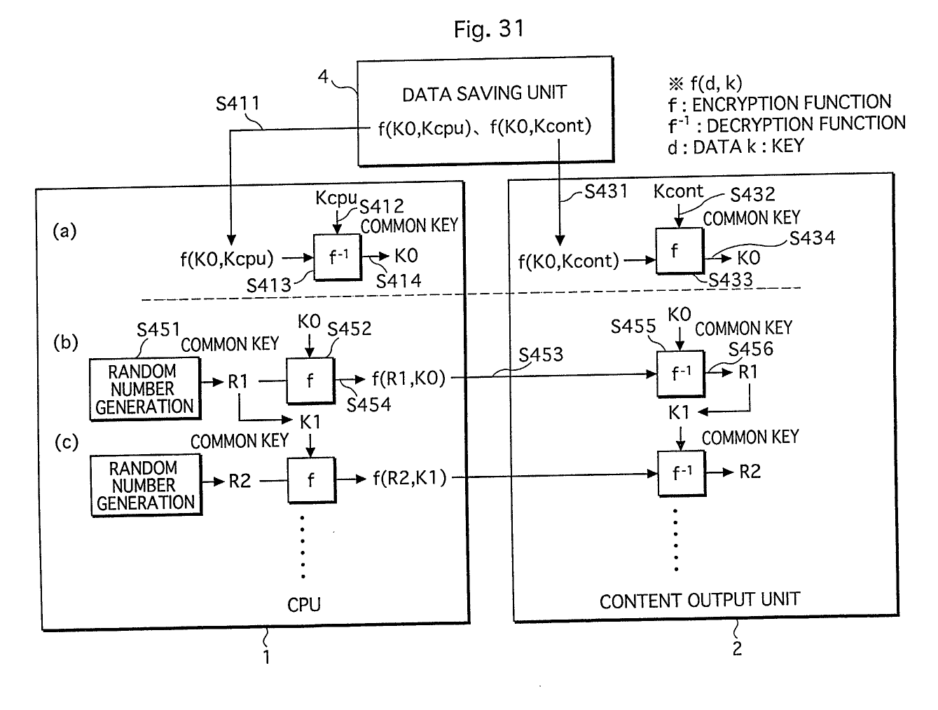

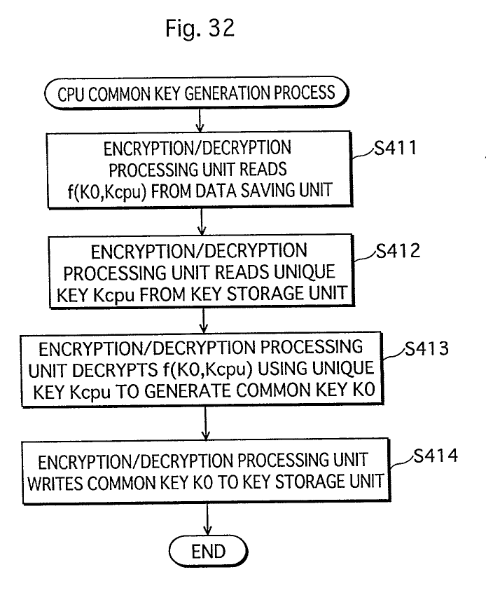

The following described operations of the CPU 1 in key sharing, with use of FIGS. 31 and 32.

The encryption/decryption processing unit 103 of the CPU 1 reads the encrypted key f(K0, Kcpu) from the data saving unit 4 (step S411) and the unique key Kcpu from the key storage unit 104 (step S412), and applies the decryption algorithm f⁻¹ to the encrypted key f(K0, Kcpu) using the unique key Kcpu as the key, to generate a common key K0 (step S413). Then the encryption/decryption processing unit 103 writes the generated common key K0 to the key storage unit 104 (step S414).

<Operations of the content output unit 2d>

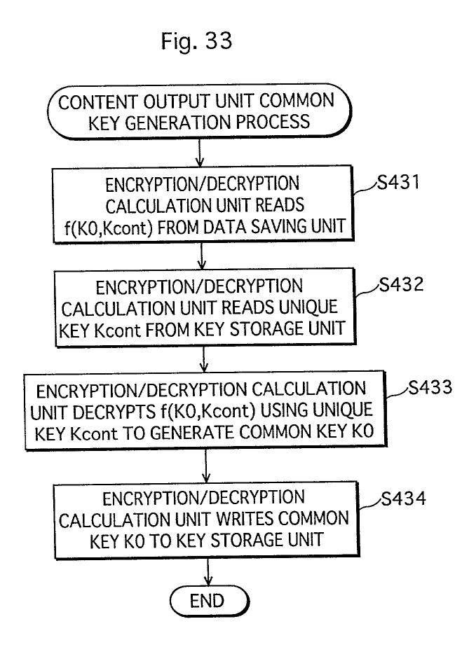

The following describes operations of the content output unit 2d with use of FIGS. 31 and 33.

The encryption/decryption calculation unit 204 of the content output unit 2d reads the encrypted key f(K0, Kcont) from the data saving unit 4 (step S431) and the unique key Kcont from the key storage unit 205 (step S432), and applies the decryption algorithm f⁻¹ to the encryption key f(K0, Kcont) using the unique key Kcont, to generate the common key K0 (step S433). Then, the encryption/decryption calculation unit 204 writes the generated common key K0 to the key storage unit 205 (step S434).

(2) Operations in key sharing of the CPU 1 and the content output unit 2d

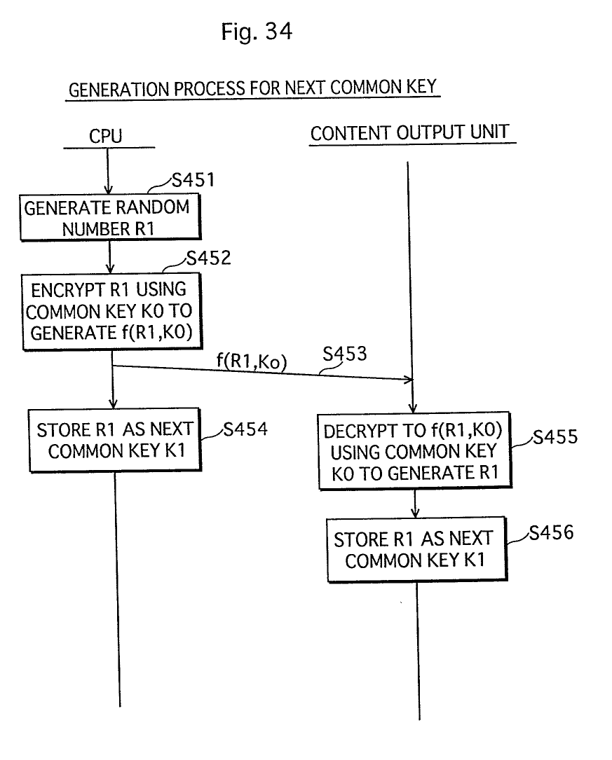

The following further describes operations in key sharing of the CPU 1 and the content output unit 2d with use of the flowchart shown in FIG. 34, and in particular describes operations for setting a common key K1, which is the next common key after the initial value K0.

The encryption/decryption processing unit 103 generates a random number R1 (step S451), and encrypts R1 using the common key K0 to generate f(R1, K0) (step S452), which it outputs to the content output unit 2d via the bus control unit 102 and the system bus 8 (step S453). In addition, the encryption/decryption processing unit 103 writes the generated random number R1 to the key storage unit 104 as a next common key k1 (step S454).

The encryption/decryption calculation unit 204 of the content output unit 2d receives f(R1, K0) from the encryption/decryption processing unit 103 (step S453), decrypts f(R1, K0) using the common key K0 as the key, to generate the next common key K1 (step S455), and writes the generated common key k1 to the key storage unit 205 (step S456).

Setting operations for a next common key K2, and then yet a next common key K3, and so on, are performed in the same manner.

3.3 Conclusion

As has been described, unique keys unique to the CPU 1 and the content output unit 2d are pre-stored respectively in the key storage units 104 and 205. The instruction execution unit 101 reads the encrypted common keys f(K0, Kcpu) and f(K0, Kcont) from the data saving unit 4, and outputs the read encrypted common keys to the data input storage unit 202 of the data input storage unit 2. Next, the instruction execution unit 101 outputs instructions to calculate the initial value of the common key to both the encryption/decryption control unit 133 and the encryption/decryption control unit 203. Under the control of the encryption/decryption control units 133 and 203 the common key kO is calculated in both the CPU 1 and the content output unit 2d, and stored in the key storage units 104 and 205.

Next, when the instruction execution unit 101 has output a common key update instruction to the encryption/decryption processing unit 103 in the CPU 1, a random number generated in the random number generation unit 140 is stored in the key storage unit 104 as a new common key K1. Then, the new common key is encrypted by the encryption calculation circuit 134 using the current common key K0, and the result transmitted under the control of the instruction execution unit 101 to the content output unit 2d.

The instruction execution unit 101 also outputs a common key update instruction to the encryption/decryption control unit 203. The current common key K0 is invoked from the key storage unit 205 to the encryption/decryption calculation unit 204 under the control of the encryption/decryption control unit 203. Accordingly, the encrypted new common key K1 transmitted from the CPU 1 is decrypted by the encryption/decryption calculation unit 204, and then stored in the key storage unit 205. In this way, a new common key K1 is shared between the CPU 1 and the content output unit 2d.

If the above-described system is used, the device manufacturer, who is the only one knowing the unique keys Kcpu and Kcont of the CPU 1 and the content output unit 2d, can update the initial value of the common key K0 by changing the value of f(K0, Kcpu) and f(K0, Kcont) stored in the data saving unit 4.

Next, the CPU 1 retrieves the random number R1 from the random number generation unit 140 and makes R1 the new common key K1. After being encrypted in the encryption/decryption processing unit 103 of the CPU 1 using the current common key K0, K1 is transferred to the content output unit 2d where it is decrypted, and the new k1 is then shared between the CPU 1 and the content output unit 2.

After this the common key may be updated after each access that uses the common key, meaning that the danger of continuously using the same common key can be completely avoided.

Note that is the above-described embodiments the value of the random number R1 is used as is as the new common key K1, as shown in FIG. 31, however, it is possible to use some kind of calculation such as performing exclusive OR on the common keys R1 and K1 and use that value as the next common key.

Note that if an updated key is re-stored in a non-volatile memory, updated common key data can be saved even when the power is not turned on. Therefore, it is possible to have a system in which a common key that has been used once is not used again. This has an effect of further heightening security.

Note that in the present embodiment a key is shared between the CPU 1 and the content output unit 2d, but the key may be shared between the CPU 2 and the memory card 20 by according to the same structure.

4. Fourth Embodiment

The following describes a portable information terminal 10e (not illustrated) as a variation of the portable information terminal 10d. The description focuses on the differences between the portable information terminal 10d and the 10e.

The object of the portable information terminal 10e is to improve security by increasing the amount of data processing in the portable information terminal 10e when, even if authentication is successful at first, further authentication fails.

Both the CPU 1 and the memory card 20 pre-store a common key Ka. Furthermore, both the CPU 1 and the content output unit 2d pre-store a common key Kb.

The CPU 1 and the memory 20 perform mutual device authentication using the common key Ka. Furthermore, the CPU 1 and the content unit 2d perform mutual device authentication using the common key 2d.

4.1 State transition of the encryption/decryption control unit 133

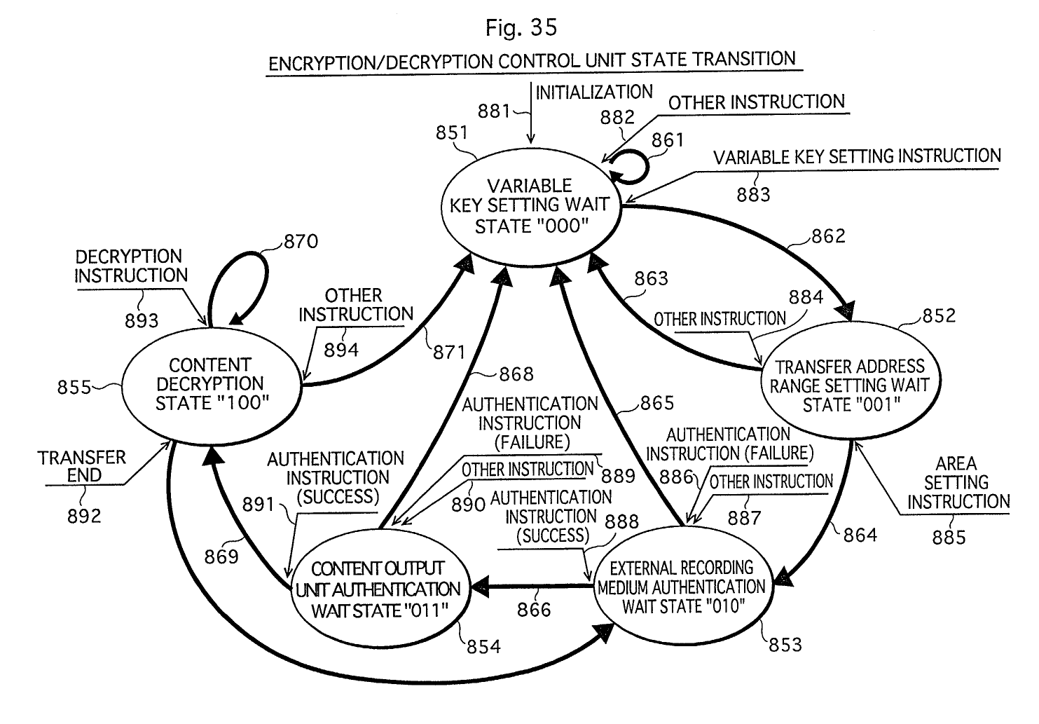

The following describes the state transition of the encryption/decryption control unit 133, with use of FIG. 35. As in FIG. 6, the thin arrows represent events occurring, while the thick arrows represent state transition following the event.

After the variable key has been first set (event 881), the encryption/decryption control unit 133 is in a variable key setting wait state 851 (hereinafter “state 851”).

On receiving a variable setting instruction in the state 851 (event 883), the encryption/decryption control unit 133 transitions to a transfer destination address range setting wait state 852 (hereinafter “state 852”) (862).

On receiving an instruction other than the variable key setting instruction in the state 851 (event 882), the encryption/decryption control unit 133 maintains the state 851 (861).

On receiving a range setting instruction in the state 852 (event 885), the encryption/decryption control unit 133 transitions to an external recording medium authentication wait state 853 (hereinafter “state 853”) (864).

On receiving an instruction other than a range setting instruction in the state 852 (event 884), the encryption/decryption control unit 133 transitions to the state 851 (863).

On receiving an authentication instruction and authentication succeeding in the state 853 (event 888), the encryption/decryption control unit 133 transitions to a content output unit authentication wait state 854 (hereinafter “state 854”) (866).

On receiving an authentication instruction and authentication failing(event 886) or on receiving an instruction other than an authentication instruction (event 887) in the state 853, the encryption/decryption control unit 133 transitions to the state 851 (865).

On receiving an authentication instruction and authentication succeeding in the state 854 (event 891), the encryption/decryption control unit 133 transitions to a content decryption state 855 (hereinafter “state 855”) (869).

On receiving an authentication instruction and authentication failing (event 889) or on receiving an instruction other than an authentication instruction (event 890) in the state 854, the encryption/decryption control unit 133 transitions to the state 851 (868).

On receiving a decryption instruction in the state 855 (event 893), the encryption/decryption control unit 133 maintains the state 855 (870).

On receiving information showing the end of transmission in the state 855 (event 892), the encryption/decryption control unit 133 transitions to the state 853 (867).

On receiving an instruction other than a decryption instruction and a transfer end instruction (event 894), the encryption/decryption control unit 133 transitions to the state 851 (871).

In this way, the encryption/decryption control unit 133 executes only the instruction corresponding to each state, and transitions to the state 851 on receiving an instruction other than the corresponding instruction, therefore the effort required for a third party to perform a brute force attack on the keys is greatly increased.

4.2 Operations of the state transition processing by the encryption/decryption control unit 133

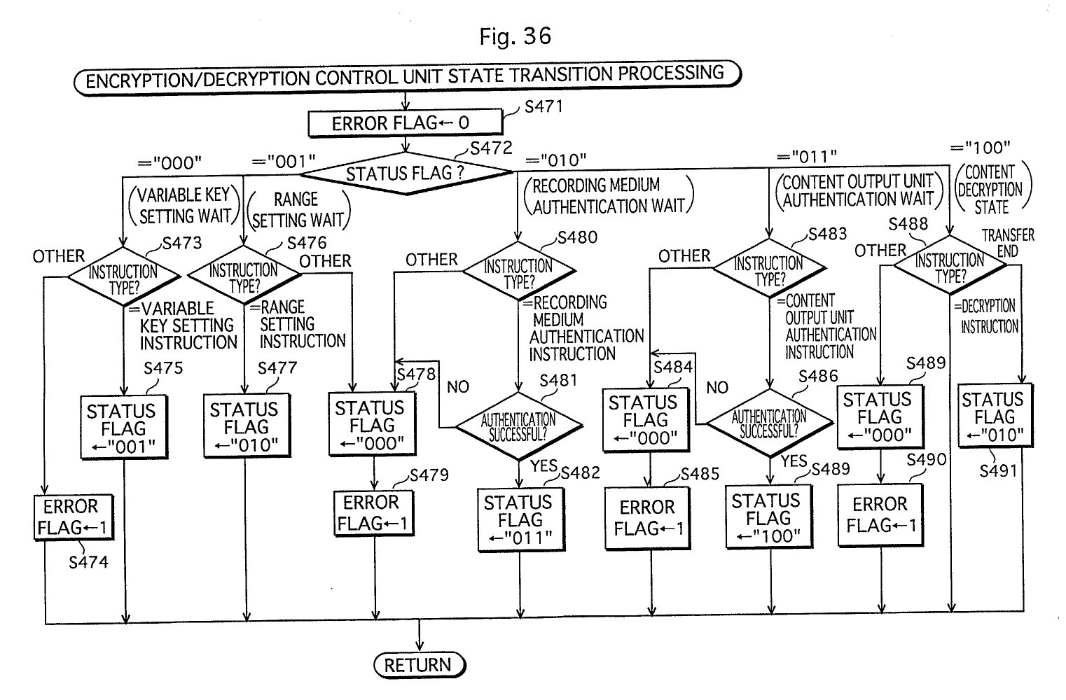

The following describes operations of state transition processing according to the encryption/decryption control unit 133, with use of the flowchart in FIG. 36.

The encryption/decryption control unit 133 sets the value of the error flag to “0” (step S471), and then judges whether, the status f1ag is any of “000”, “001”, “010”, “011”, or “100”.

When the status f1ag is “000” (step S472) the encryption/decryption control unit 133 further distinguishes the type of instruction, and if the instruction is a variable key setting instruction (step S473), sets the status f1ag to “001” (step 475), and ends the state transition processing operation.

If the instruction is any other instruction (step S473), the encryption/decryption control unit 133 sets the error f1ag to “1” (step S474), and ends the state transition processing operation.

When the status f1ag is “001” (step S472), the encryption/decryption control unit 133 further distinguishes the type of instruction, and if the instruction is a range setting instruction (step S476), sets the status f1ag to “01”) and ends the state transition processing operation (step S477).

If the instruction is any other instruction (step S476), the encryption/decryption control unit 133 sets the status f1ag to “000” (step S478), sets the error f1ag to “1” (step S479), and ends the state transition processing operation.

If the status f1ag is “010” (step S472), the encryption/decryption control unit 133 further distinguishes the type of the instruction, and if the instruction is an authentication instruction (step S480) and if authentication is successful (step S481), sets the status f1ag to “011” (step S482), and ends the state transition processing operation.

Furthermore, if the instruction is an authentication instruction (step S480) and the authentication result is failure (step S481), the encryption/decryption control unit 133 sets the status f1ag to “000” (step S478), sets the error f1ag to “1” (step S479), and ends the state transition processing operation.

If the instruction is any other instruction (step S480) the encryption/decryption control unit 133 sets the status f1ag to “000” (step S478), sets the error f1ag to “1” (step S479), and ends the state transition processing operation.

When the status f1ag is “011” (step S472) the encryption/decryption control unit 133 further distinguishes the type of the instruction, and if the instruction is an authentication instruction (step S483) and if the authentication result is success (step S486), sets the authentication f1ag to “100” (step S487), and ends the state transition processing operation.

Furthermore, if the instruction is an authentication instruction (step S483) and the authentication result is failure (step S486), the encryption/decryption control unit 133 sets the status f1ag to “000” (step S484), sets the error f1ag to “1” (step S485), and ends the state transition processing operation.

If the instruction is any other instruction (step S483) the encryption/decryption control unit 133 sets the status f1ag to “000” (step S484), sets the error f1ag to “1” (step S485), and ends the state transition processing operation.

When the status f1ag is “100” (step S472), the encryption/decryption control unit 133 further distinguishes the type of instruction, and if the instruction is a decryption instruction (step S488), ends the state transition processing operation.

Furthermore, on receiving information showing the end of transferring (step S488), the encryption/decryption control unit 133 sets the status f1ag to “010” (step S491), and ends the state transition processing operation.

If the instruction is any other instruction (step S488) the encryption/decryption control unit 133 sets the status f1ag to “000” (step S489), sets the error f1ag to “1” (step S490), and ends the state transition processing operation.

4.3 Conclusion

The state machine provided in the encryption/decryption control unit 133 operates as shown in FIG. 35. The difference between FIG. 6 and FIG. 35 is that after successful authentication with the memory card 20, decryption of content (including the content key) is not performed unless authentication with the content output unit 2d is also successful.

When the CPU 1, the content output unit 2d, and the memory card 20 are legal modules, the common key is provided accurately between these modules, therefore as shown in FIG. 35 authentication failure does not occur when performing authentication with the memory card 20 and with the content output unit 2d in succession.

The following describes a case in which a third party who attempts to obtain decrypted content illegally replaces the content output unit 2d with an illegal content output unit 2x.

The content output unit 2x does not store the common key Kb, therefore device authentication is performed repeatedly while the third party changes the value of the common key over and over again, until device authentication succeeds. Here, if authentication fails-once, it is necessary to reset the initial setting of the CPU 1 and start from authentication with the memory card 20 again. As a result, security is heightened because the time required for a brute force attack to reveal the common key is greatly increased.

5. Fifth Embodiment

The following describes a portable information terminal 10f as a variation of the portable information terminal 10e. Here, the description focuses on the differences in the portable information terminal 10f to the portable information terminal 10e.

The object of the portable information terminal 10f is to reduce the amount of calculation in encrypting content.

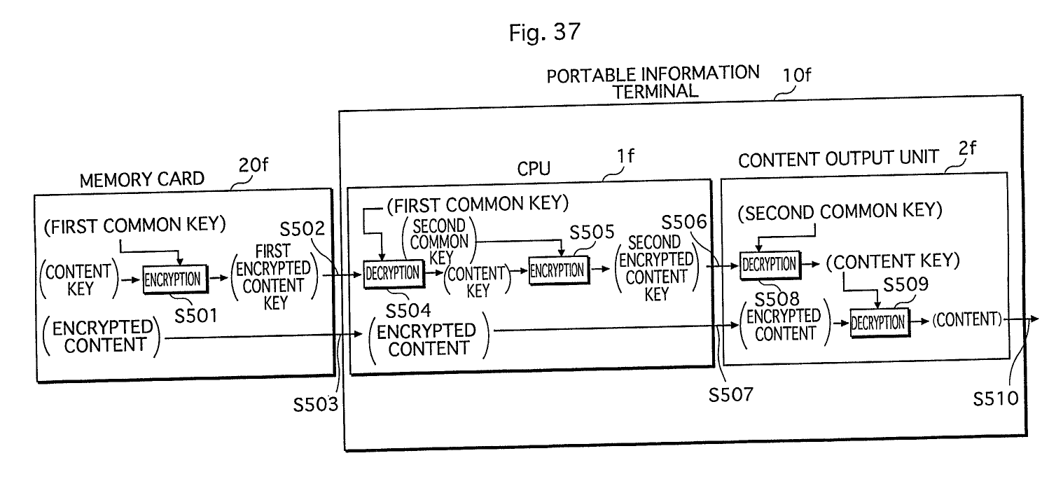

As FIG. 37 shows, the portable information terminal 10f includes a CPU 1f and a content output unit 2f. Furthermore, a memory card 20f is inserted in the portable information terminal 10f.

A common key is set between the CPU if and the memory card 20f, and another common key is set between the CPU 1f and the content output unit 2f. The common keys are saved in a key storage unit in each of the CPU 1f, the content output unit 2f, and the memory card 20f. Specifically, the memory card 20f and the CPU 1f pre-store a first common key Ka. Furthermore, the CPU 1 and the content output unit 2f pre-store a second common key Kb.

Encrypted content that is transferred from the memory card 20f is transferred as is to the content output unit 2f under the control of the instruction execution unit 101, without being encrypted/decrypted in the CPU 1f. Meanwhile, the content key that has been encrypted with the first common key is decrypted in the decryption calculation circuit 135 and then stored in the key storage unit 104 of the CPU 1. Then the content key is input through the data input storage unit 132 to the encryption calculation circuit 134, and after being re-encrypted with the second common key, is transferred to the content output unit 2f under the control of the instruction execution unit 101.

<Operations of the memory card 20f, the CPU 1f, and the content output unit 2f>

The memory card 20f encrypts the content key using the first common key Ka as the key, to generate a first encrypted content key (step S501), and outputs the generated first encrypted content key to the CPU 1f (step S502). Furthermore, the memory card 20f outputs the encrypted content to the CPU 1f (step S503).

Next, the CPU 1f receives the first encrypted content key (step S502) which it decrypts using the first common key Ka as the key, to generate the content key (step S504). Next, the CPU 1f encrypts the generated content key using the second common key 2b as the key to generate a second encrypted content key (step S505), and outputs the generated second encrypted content key to the content output unit 2f (step S506). Furthermore, the CPU 1f receives the encrypted content (step S503), and outputs the received encrypted content to the content output unit 2f (step S507).

Next, the content output unit 2f receives the second encrypted content key (step S506), and decrypts the received second encrypted content key using the second common key Kb as the key, to generate the content key (step S508). Next, the content output unit 2f receives the encrypted content (step S507), decrypts the received encrypted content using the generated content key to generate the content (step S509), and outputs the generated content to an external device (step S510).

As has been described, when the portable information terminal 10f transfers encrypted content from the memory card 20f via the CPU 1f on the system bus 8 to the content output unit 2f in an encrypted state, the content is not decrypted or re-encrypted in the CPU 1f. Therefore, calculation of encryption/decryption of content that has a large amount of data is completed eliminated.

6. Overall Conclusion

As has been explained, according to the present invention while maintaining the function of the user being able to executing downloading programs arbitrarily from an external device, illegal operations in the CPU according to the software obtained from the external device can be limited. Furthermore, the present invention can be realized without changing the basic structure of the a conventional CPU. Furthermore, content can be transferred over the bus connected to the CPU, while maintaining security.

Note that the present invention is not limited to the above-described embodiments. Cases such as the following are included in the present invention.

(1) The present invention may be a method showing any of the above-described embodiments. Furthermore, the present invention may be a computer program that implements any of the methods, and may be a digital signal that is composed of the aforementioned computer program.

Furthermore, the present invention may be the aforementioned computer program or the aforementioned digital signal recorded on a computer-readable recording medium such as a flexible disk, a hard disk, a CD-ROM (compact disk read only memory), an MO (magneto-optical), a DVD, a DVD-ROM (digital versatile disk read only memory), a DVD-RAM(digital versatile disk random access memory), a semiconductor memory, and the like. Furthermore, the present invention may be the aforementioned computer program or the aforementioned digital signal recorded on any of the aforementioned recording mediums.

Furthermore, the present invention may be the aforementioned computer program or the aforementioned digital signal transmitted via an electric communication line, a wireless or wired communication line, a network of which the internet is representative, and the like.

Furthermore, the present invention may be a computer system that has a microprocessor and a memory, the memory storing the aforementioned computer program, and the microprocessor operating following the aforementioned computer program.

Furthermore, by recording and transferring the aforementioned program or the aforementioned digital signal on the aforementioned recording medium, or by transferring the aforementioned program or the aforementioned digital signal via the aforementioned network, the aforementioned program or the aforementioned digital signal may be implemented by another independent computer system.

(2) The present invention may be any combination of the above-described embodiments and the above-described variations.

Although the present invention has been fully described by way of examples with reference to accompanying drawings, it is to be noted that various changes and modifications will be apparent to those skilled in the art. Therefore, unless such changes and modifications depart from the scope of the present invention, they should be construed as being included therein.

What is claimed is:

1. A content decryption device that decrypts encrypted content that is recorded on a recording medium, and outputs the decrypted content to an external device, comprising:
decryption means for decrypting the encrypted content to generate the decrypted content; and
instruction execution means for decoding a transfer instruction that includes a transfer destination address showing a position of a content output means in an address space as a transfer destination of the decrypted content to extract the transfer destination address, and outputting the extracted transfer destination address to an address detection means;
the address detection means for pre-storing a permitted address that shows a transfer destination to which output of the decrypted content is permitted, judging whether the transfer destination address matches the permitted address, and outputting, only when the transfer destination address matches the permitted address, the decrypted content to the content output means whose position is shown by the transfer destination address; and
the content output means for receiving the decrypted content, and outputting the received decrypted content to the external device.

2. The decryption device of claim 1 further comprising:
obtaining means for obtaining, from another external device, a decryption program including (a) a decryption instruction that shows decryption of encrypted content, and (b) a transfer instruction that includes the transfer destination address showing the position in the content output means, and that shows transfer of the decrypted content to the content output means,
wherein the decryption means decrypts the encrypted content according to the decryption instruction, and
the instruction execution means outputs the transfer destination address according to the transfer instruction.

3. The content decryption device of claim 2,
wherein the decryption means, the instruction execution means, the address detection means, the content output means and the obtaining means are connected via a bus,
the instruction execution means outputs the transfer destination address via the bus,
the address detection means obtains the transfer destination address via the bus, and outputs the decrypted content via the bus, and
the content output means receives the decrypted content via the bus.

4. The content decryption device of claim 3,
wherein the address detection means further has a state in which the permitted address is not stored, and
the content decryption device further comprises:
state control means for judging whether the address detection means stores the permitted address, and, when the address detection means is judged not to store the permitted address, prohibiting the instruction execution means from executing the transfer instruction.

5. The content decryption device of claim 3,
wherein the obtaining means further obtains, from the other external device, an encrypted permitted address that is a new permitted address which has been encrypted,
the decryption means decrypts the encrypted permitted address to generate the new permitted address, the address detection means stores the generated new permitted address in place of the permitted address, and when encrypted content is next decrypted, judges whether the transfer destination address and the new permitted address match.

6. The content decryption device of claim 5,
wherein the decryption means pre-stores a variable key, and decrypts the encrypted permitted address using the variable key.

7. The content decryption device of claim 6,
wherein the decryption means further pre-stores a unique key that is unique to the content decryption device,
the obtaining means further obtains an encrypted variable key that is a new variable key that has been encrypted using the unique key,
the decryption means decrypts the encrypted variable key using the unique key to generate the new variable key, and stores the generated new variable key in place of the variable key, and uses the new variable key when next decrypting a permitted address that has been encrypted using the new variable key.

8. The content decryption device of claim 6,
wherein the decryption means further has a state in which the variable key is not stored, and
the state control means further judges whether the decryption means stores the variable key, and, when the decryption means is judged not to store the variable key, prohibits the decryption means from decrypting.

9. The content decryption device of claim 1,
wherein the decryption means, the instruction execution means and the address detection means together compose a CPU,
a first authentication is performed between the CPU and the recording medium, and following the first authentication a second authentication is performed between the CPU and the content output unit, and
the content decryption device decrypts the encrypted content and outputs the decrypted content to the external device only when both the first authentication and the second authentication are successful.

10. A content decryption device that decrypts encrypted content and outputs the decrypted content to an external device, comprising:
obtaining means for obtaining, from another external device, a decryption program that includes a program for decrypting encrypted content and outputting the decrypted content to the external device, and that includes first encrypted information and second encrypted information, the first encrypted information having been generated by encrypting a predetermined piece of information according to a first encryption, the second encrypted information having been generated by encrypting the predetermined piece of information according to a second encryption;
storage means for storing the program;
decryption means for decrypting the first encrypted information according to a first decryption to generate first decrypted information, and decrypting the second encrypted information according to a second decryption to generate second decrypted information, the first decryption being an inverse transformation of the first encryption, and the second decryption being an inverse transformation of the second encryption; and
judgement means for judging whether the first decrypted information and the second decrypted information match, and when the first decrypted information and the second decrypted information are judged not to match, prohibiting execution of the program.

11. The content decryption device of claim 10,
wherein the first encryption is encryption in which a predetermined encryption algorithm is applied using a first key,
the second encryption is encryption in which the predetermined encryption algorithm is applied using a second key,
the first decryption is decryption in which a predetermined decryption algorithm is applied using a first key, the predetermined decryption algorithm being an inverse transformation of the predetermined encryption algorithm, and
the second decryption is decryption in which the predetermined decryption algorithm is applied using a second key.

12. The content decryption device of claim 10,
wherein the first encryption is encryption in which a first encryption algorithm is applied using an encryption key,
the second encryption is encryption in which a second encryption algorithm is performed using the encryption key,
the first decryption is decryption in which a first decryption algorithm is performed using the encryption key, the first decryption algorithm being an inverse conversion of the first encryption algorithm, and
the second decryption is decryption in which the second decryption algorithm is performed using the encryption key, the second decryption algorithm being an inverse conversion of the second encryption algorithm.

13. The content decryption device of claim 10, further comprising:
control means for executing initialization of the content decryption device when the judgement means judges that the first decrypted information and the second decrypted information do not match.

14. The content decryption device of claim 10,
wherein the control means further, when the first decrypted information and the second decrypted information are judged not to match, requests the user to have the program stored in the storage means.

15. The content decryption device of claim 14,
wherein the control means further judges whether the program has been updated, and, when the program is judged not to have been updated, prohibits execution of the program.

16. A content decryption device that decrypts encrypted content and outputs the decrypted content to an external device, comprising:
data storage unit for storing (a) a first encrypted key that has been generated by encrypting a common key using a CPU unique key that is unique to a CPU, and (b) a second encrypted key that has been generated by encrypting a common key using a content processing unit unique key that is unique to a content processing unit;
the CPU for performing execution of instructions, encryption of information, and decryption of information, and for generating a common key by decrypting the first encrypted key using the CPU unique key, and storing the generated common key,
the content processing unit for (a) storing content, or outputting stored content to the external device, and (b) generating a common key by decrypting the second encrypted key using the content processing unit unique key.

17. The content decryption device of claim 16,
wherein the CPU includes:
a key generation sub-unit for generating a new common key;
an encryption sub-unit for encrypting the new common key using the common key to generate an encrypted common key;
an output sub-unit for outputting the generated encrypted common key to the content processing unit; and
a key updating sub-unit for storing the new common key in place of the common key; and
the content processing unit includes:
an obtaining sub-unit for obtaining an encrypted common key;
a decryption sub-unit for decrypting the obtained encrypted common key using the common key to generate a new common key; and
a key updating sub-unit for storing the new common key in place of the common key.

18. The content decryption device of claim 16,
wherein the CPU includes:
an information storage sub-unit for storing predetermined information;
an encryption unit for encrypting the predetermined information using the common key to generate encrypted information;
an output sub-unit for outputting the generated encrypted information to the content processing unit; and
a key calculation sub-unit for applying a predetermined calculation to the common key and the predetermined information to generate a new common key, and storing the generated new common key in place of the common key, and
the content processing unit further includes:
an obtaining sub-unit for obtaining encrypted information;
a decryption sub-unit for decrypting the obtained encrypted information using the common key to generate a new common key; and
a key calculation sub-unit for applying a predetermined calculation that is the same as the predetermined calculation. to the common key and the predetermined information to generate a new common key, and storing the generated new common key in place of the common key.
